(19) United States
(12) Patent Application Publication
(10) Pub. No.: US 2026/0219425 A1
(43) Pub. Date: Jul. 30, 2026

(54) OPTICAL LAMINATE, LAMINATED OPTICAL FILM, AND OPTICAL ARTICLE

(71) Applicant: FUJIFILM Corporation, Tokyo (JP)

(72) Inventor: Ryuji SANETO, Minamiashigara-shi (JP)

(73) Assignee: FUJIFILM Corporation, Tokyo (JP)

(21) Appl. No.: 19/572,906

(22) Filed: Mar. 20, 2026

Related U.S. Application Data
(63) Continuation of application No. PCT/JP2024/037964, filed on Oct. 24, 2024.

(30) Foreign Application Priority Data
Oct. 31, 2023 (JP) 2023-186705

(51) Int. Cl. G02B 5/08; G02B 5/30

(52) U.S. Cl. CPC G02B 5/0841; G02B 5/3016

(57) ABSTRACT

An optical laminate includes a selective reflection layer having at least one cholesteric liquid crystal layer, and a first adjacent layer disposed adjacent to an outermost cholesteric liquid crystal layer, the first adjacent layer being an optically isotropic layer or a C-plate. For the outermost cholesteric liquid crystal layer, a long-wavelength half-value wavelength λmax, a short-wavelength half-value wavelength λmin, and a number of helical pitches P are defined. Refractive indices nmax and nmin are determined as λmax/P and λmin/P, respectively. A refractive index n1 of the first adjacent layer satisfies nmax>n1, nmin<n1, and |(nmax·nmin)½−n1|≤0.03, thereby providing controlled optical characteristics.

### CROSS-REFERENCE TO RELATED APPLICATIONS

This application is a Continuation of PCT International Application No. PCT/JP2024/037964 filed on Oct. 24, 2024, which claims priority under 35 U.S.C. § 119 (a) to Japanese Patent Application No. 2023-186705 filed on Oct. 31, 2023. The above applications are hereby expressly incorporated by reference, in their entirety, into the present application.

### BACKGROUND OF THE INVENTION

### 1. Field of the Invention

The present invention relates to an optical laminate. In addition, the present invention relates to a laminated optical film including an optical laminate, and an optical article including the laminated optical film.

### 2. Description of the Related Art

In recent years, a virtual reality display apparatus has been put into practical use.

Examples of the virtual reality display apparatus include a head-mounted display including a display panel and a lens. In a case where such a head-mounted display is mounted on a head of an observer and a video is displayed through the lens, the observer can visually recognize a video with a realistic effect.

In such a head-mounted display, in order to reduce the thickness thereof, a lens using a reflective optical system may be adopted. For example, in JP1995-120679A (JP-H7-120679A), in order to reduce the size and thickness of a display unit in a virtual reality display apparatus or the like, a method of generating a virtual image by reflecting and reciprocating light between a reflective polarizer and a half mirror is disclosed.

### SUMMARY OF THE INVENTION

In recent years, in a virtual reality display apparatus, there has been a demand for a clearer image to be visually recognized.

In a case where the present inventors have studied a head-mounted display adopting the reflective optical system described in JP1995-120679A (JP-H7-120679A), a ghost (undesired image) may be observed, and thus there has been a demand for reducing the occurrence of the ghost.

Therefore, an object of the present invention is to provide an optical laminate in which a ghost is less likely to occur in a case of being applied to a head-mounted display.

In addition, another object of the present invention is to provide a laminated optical film and an optical article.

The present inventors conducted a thorough investigation to achieve the object, thereby completing the present invention. That is, the present inventors have found that the above-described objects can be achieved by the following configurations.
[1] An optical laminate comprising:
a selective reflection layer including at least one cholesteric liquid crystal layer; and a first adjacent layer that is disposed adjacent to an outermost cholesteric liquid crystal layer disposed on an outermost side of the selective reflection layer and that is selected from the group consisting of an optically isotropic layer and a C-plate,
in which, in a case where a half-value wavelength on a long wavelength side of a reflection spectrum of the outermost cholesteric liquid crystal layer is denoted by λmax, a half-value wavelength on a short wavelength side of the reflection spectrum of the outermost cholesteric liquid crystal layer is denoted by λmin, and the number of helical pitches of the outermost cholesteric liquid crystal layer is denoted by P, relationships of Expression (3) to Expression (5) are satisfied between nmax and nmin calculated by Expression (1) and Expression (2) and a refractive index n1 of the first adjacent layer on an outermost cholesteric liquid crystal layer side,

$$n max = λmax / P , \qquad Expression ( 1 )$$

$$n min = λmin / P , \qquad Expression ( 2 )$$

$$n max > n 1 , \qquad Expression ( 3 )$$

$$n min > n 1 , \qquad Expression ( 4 )$$

$${( n max \cdot n min )}^{1 / 2} - n 1 \vert \leq 0.03 . \qquad Expression ( 5 )$$

[2] The optical laminate according to [1], in which the selective reflection layer includes a cholesteric liquid crystal layer R formed of a rod-like liquid crystal compound and a cholesteric liquid crystal layer D formed of a disk-like liquid crystal compound.
[3] The optical laminate according to [1] or [2], in which a reflectance of light having a wavelength of 450 to 650 nm is 40% or more and less than 50%.
[4] The optical laminate according to any one of [1] to [3], in which the first adjacent layer has a liquid crystal alignment capability.
[5] The optical laminate according to any one of [1] to [4], in which a refractive index of the first adjacent layer changes from a surface on the outermost cholesteric liquid crystal layer side toward a surface on a side opposite to the outermost cholesteric liquid crystal layer side.
[6] The optical laminate according to any one of [1] to [5], further comprising: a second adjacent layer that is disposed adjacent to a side of the first adjacent layer opposite to a selective reflection layer side,
in which a refractive index n2 of the first adjacent layer on a second adjacent layer side and a refractive index n3 of the second adjacent layer on a first adjacent layer side satisfy a relationship of Expression (6),

$$n 3 - n 2 \vert \leq 0.03 . \qquad Expression ( 6 )$$

[7] A laminated optical film comprising, in the following order: the optical laminate according to any one of [1] to [6]; a retardation layer; and a polarizer,
in which the retardation layer is disposed on a side of the selective reflection layer of the optical laminate opposite to the first adjacent layer side.
[8] An optical article comprising: the laminated optical film according to [7]; and a lens disposed on a side of the first adjacent layer of the laminated optical film opposite to a selective reflection layer side.
[9] An optical laminate comprising: a reflective type linear polarizer;
a retardation layer; and
a first adjacent layer selected from the group consisting of an optically isotropic layer and a C-plate, the first adjacent layer being disposed adjacent to the retardation layer on a side of the retardation layer opposite to a reflective type linear polarizer side,
in which in a case where a refractive index of the retardation layer in an in-plane slow axis direction is denoted by nx1, a refractive index of the retardation layer in an in-plane fast axis direction is denoted by ny1, and a refractive index of the first adjacent layer on the retardation layer side is denoted by n4, relationships of Expression (7) to Expression (9) are satisfied,

$$nx 1 > n 4 , \qquad Expression ( 7 )$$

$$ny 1 < n 4 , \qquad Expression ( 8 )$$

$${( nx 1 \cdot ny 1 )}^{1 / 2} - n 4 \vert \leq 0.03 . \qquad Expression ( 9 )$$

[10] The optical laminate according to [9], in which the retardation layer contains a liquid crystal compound.
[11] The optical laminate according to [9] or [10], in which a reflectance of light having a wavelength of 450 to 650 nm is 40% or more and less than 50%.
[12] The optical laminate according to any one of [9] to [11], in which the first adjacent layer has a liquid crystal alignment capability.
[13] The optical laminate according to any one of [9] to [12], in which a refractive index of the first adjacent layer changes from a surface on the reflective type linear polarizer side toward a surface on a side opposite to the reflective type linear polarizer side.
[14] The optical laminate according to any one of [9] to [13], further comprising: a second adjacent layer that is disposed adjacent to a side of the first adjacent layer opposite to the reflective type linear polarizer side,
in which a refractive index n5 of the first adjacent layer on a second adjacent layer side and a refractive index n6 of the second adjacent layer on a first adjacent layer side satisfy a relationship of Expression (10),

$$\vert n 6 - n 5 \vert \leq 0.03 . \qquad Expression ( 10 )$$

[15] A laminated optical film comprising: the optical laminate according to any one of [9] to [14]; and a polarizer disposed on the reflective type linear polarizer side of the optical laminate.
[16] An optical article comprising: the laminated optical film according to [15]; and a lens disposed on a side of the first adjacent layer of the laminated optical film opposite to a reflective type linear polarizer side.

According to the present invention, it is possible to provide an optical laminate in which ghost is less likely to occur in a case of being applied to a head-mounted display.

In addition, according to the present invention, it is also possible to provide a laminated optical film and an optical article.

### BRIEF DESCRIPTION OF THE DRAWINGS

FIG. 1 is a schematic cross-sectional view of an example of an optical laminate according to a first embodiment of the present invention.

FIG. 2 is a schematic cross-sectional view of an example of an optical laminate according to a second embodiment of the present invention.

FIG. 3 is a schematic view of a virtual reality display apparatus to which the optical laminate according to the present invention is applied.

### DESCRIPTION OF THE PREFERRED EMBODIMENTS

Hereinafter, the present invention will be described in detail.

The description of the configuration requirements described below may be made based on the representative embodiments of the present invention, but the present invention is not limited to those embodiments.

Hereinafter, meaning of each description in the present specification will be explained.

In the present specification, numerical ranges represented by “to” include numerical values before and after “to” as lower limits and upper limits.

In the present specification, the term “orthogonal” does not denote 90° in a strict sense, but denotes 90°±10°, preferably 90°±5°. In addition, the term “parallel” does not denote 0° in a strict sense, but denotes 0°±10°, preferably 0°±5°. Furthermore, the term “45°” does not denote 45° in a strict sense, but denotes 45°±10°, preferably 45°±5°.

In the present specification, “absorption axis” denotes a polarization direction in which an absorbance is the maximum in a plane in a case where linearly polarized light is incident. In addition, the term “reflection axis” denotes a polarization direction in which reflectance is maximized in a plane in a case where linearly polarized light is incident. In addition, the term “transmission axis” denotes a direction orthogonal to the absorption axis or the reflection axis in a plane. Furthermore, the term “slow axis” denotes a direction in which refractive index is maximized in a plane. The term “fast axis” denotes a direction in which the refractive index is minimum in a plane, and is a direction orthogonal to the slow axis.

In the present specification, the retardation denotes in-plane retardation unless otherwise specified, and is referred to as Re (λ). Here, Re (λ) represents an in-plane retardation at a wavelength λ, and the wavelength λ is 550 nm unless otherwise specified.

In addition, a retardation at the wavelength λ in a thickness direction is referred to as Rth (λ) in the present specification. The wavelength λ is set to 550 nm unless otherwise specified.

As Re(λ) and Rth(λ), values measured at the wavelength λ with AxoScan OPMF-1 (manufactured by Opto Science, Inc.) can be used. By inputting an average refractive index ((nx+ny+nz)/3) and a film thickness (d (μm)) in AxoScan,

$$a slow axis direction ( ° ) ,$$

$$Re ( λ ) = R 0 ( λ ) , and$$

$$Rth ( λ ) = ( ( nx + ny ) / 2 - nz ) \times d .$$

Examples of the optical laminate according to the embodiment of the present invention include a first embodiment and a second embodiment described later.

Hereinafter, the optical laminate according to the first embodiment and the optical laminate according to the second embodiment will be described.

### [Optical Laminate According to First Embodiment]

The optical laminate according to the first embodiment of the present invention includes a selective reflection layer including at least one cholesteric liquid crystal layer, and a first adjacent layer that is disposed adjacent to an outermost cholesteric liquid crystal layer disposed on an outermost side of the selective reflection layer and that is selected from the group consisting of an optically isotropic layer and a C-plate.

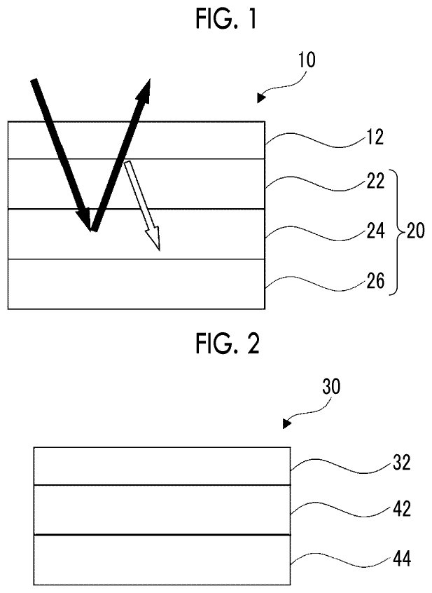

FIG. 1 is a schematic cross-sectional view showing the optical laminate according to the first embodiment of the present invention.

An optical laminate 10 of the aspect shown in FIG. 1 includes a selective reflection layer 20 and an optically isotropic layer 12. The selective reflection layer 20 includes a first cholesteric liquid crystal layer 22, a second cholesteric liquid crystal layer 24, and a third cholesteric liquid crystal layer 26, and the first cholesteric liquid crystal layer 22 is adjacent to the optically isotropic layer 12. That is, the first cholesteric liquid crystal layer 22 corresponds to the outermost cholesteric liquid crystal layer which is disposed on the outermost side of the selective reflection layer 20, and the optically isotropic layer 12 corresponds to the first adjacent layer.

As will be described later, the optical laminate according to the first embodiment of the present invention is not limited to the aspect shown in FIG. 1, and various modifications can be made.

Here, in a case where a half-value wavelength on a long wavelength side of a reflection spectrum of the outermost cholesteric liquid crystal layer (the first cholesteric liquid crystal layer 22 in FIG. 1) is denoted by λmax, a half-value wavelength on a short wavelength side of the reflection spectrum of the outermost cholesteric liquid crystal layer is denoted by λmin, and the number of helical pitches of the outermost cholesteric liquid crystal layer is denoted by P, relationships of Expression (3) to Expression (5) are satisfied between nmax and nmin calculated by Expression (1) and Expression (2) and a refractive index n1 of the first adjacent layer (the optically isotropic layer 12 in FIG. 1) on the outermost cholesteric liquid crystal layer side. A method of measuring λmax, λmin, and P will be described in detail later.

$$n max = λ max / P \qquad Expression ( 1 )$$

$$n min = λ min / P \qquad Expression ( 2 )$$

$$n max > n 1 \qquad Expression ( 3 )$$

$$n min < n 1 \qquad Expression ( 4 )$$

$$\vert {( n max \cdot n min )}^{1 / 2} - n 1 \vert \leq 0.03 \qquad Expression ( 5 )$$

In Expression (1), a refractive index corresponding to an in-plane slow axis direction of the outermost cholesteric liquid crystal layer is calculated. In addition, in Expression (2), a refractive index corresponding to an in-plane fast axis direction of the outermost cholesteric liquid crystal layer is calculated.

That is, in the optical laminate according to the first embodiment of the present invention, nmax is larger than n1 (Expression (3)), and nmin is smaller than n1 (Expression (4)) between nmax and nmin corresponding to the refractive index of the outermost cholesteric liquid crystal layer and the refractive index n1 of the first adjacent layer on the outermost cholesteric liquid crystal layer side. In addition, an absolute value of a difference between a geometric mean value of nmax and nmin corresponding to the refractive index of the outermost cholesteric liquid crystal layer and the refractive index n1 of the first adjacent layer is 0.03 or less (Expression (5)).

In the optical laminate according to the first embodiment of the present invention, in a case where the relationships of Expressions (1) to (5) are satisfied, a mechanism in which a ghost is less likely to occur in a case of being applied to a head-mounted display is not always clear, but the present inventors have presumed as follows.

In a case where the optical laminate according to the first embodiment of the present invention is applied to a head-mounted display, as will be described in detail later, a ray is reflected by the selective reflection layer in the optical laminate to reciprocate the ray, and a virtual image is visually recognized by an observer. In the optical laminate according to the first embodiment of the present invention, since the selective reflection layer includes the cholesteric liquid crystal layer, the selective reflection layer has a function of selectively reflecting a ray in a specific wavelength range of dextrorotatory circularly polarized light or levorotatory circularly polarized light without changing a polarization direction of circularly polarized light.

Here, in the optical laminate, reflection may occur at an interface between members having a difference in refractive index. In the optical laminate according to the first embodiment of the present invention, there is a possibility that unintended reflection occurs due to a difference in refractive index at an interface between the outermost cholesteric liquid crystal layer and the first adjacent layer. More specifically, light incident into the selective reflection layer from the first adjacent layer side and reflected by the selective reflection layer (see a black arrow in FIG. 1) may be reflected at the interface between the outermost cholesteric liquid crystal layer and the first adjacent layer (see a white arrow in FIG. 1). In a case where such unintended reflection occurs, an image is observed at an unintended position, and a ghost occurs. In particular, in a case where the polarization direction of circularly polarized light generated by unintended reflection changes, for example, in a case where the circularly polarized light is converted into linearly polarized light by a λ/4 plate, the polarization directions of the linearly polarized light are orthogonal to each other between the dextrorotatory circularly polarized light and the levorotatory circularly polarized light. Therefore, leakage light is generated without being absorbed by an absorptive linear polarizer or the like, and the occurrence of a ghost is likely to occur.

In a case where reflection of circularly polarized light occurs at an interface between members, it is considered that the properties of light generated by reflection are different depending on the relationship between the refractive indices of the members constituting the interface. Hereinafter, in the present paragraph, a case where light incident from the first adjacent layer side and reflected by the selective reflection layer is reflected at the interface between the first adjacent layer and the outermost cholesteric liquid crystal layer will be considered.

Hereinafter, in the present paragraph, the refractive index of the first adjacent layer is denoted by nv.

In a case where nv is large with respect to nmax and nmin of the outermost cholesteric liquid crystal layer, in a case where light is incident from the outermost cholesteric liquid crystal layer side, the reflection occurring at the interface is fixed end reflection. Therefore, in the reflected light, the phase of any component of the component in the direction indicating nmax and the component in the direction indicating nmin of the outermost cholesteric liquid crystal layer is reversed from the incident light. In this case, in a case where the incident circularly polarized light is dextrorotatory circularly polarized light, the phases of the components of light orthogonal to each other are both reversed, and the traveling direction is reversed. Therefore, the sign of the phase difference between the components of light orthogonal to each other is reversed, and the reflected light is levorotatory circularly polarized light.

On the other hand, in a case where nv is small with respect to nmax and nmin of the outermost cholesteric liquid crystal layer, in a case where light is incident from the outermost cholesteric liquid crystal layer side, the reflection occurring at the interface is free end reflection. Therefore, in the reflected light, the phase of any component of the component in the direction indicating nmax and the component in the direction indicating nmin of the outermost cholesteric liquid crystal layer does not change from the incident light. In this case, in a case where the incident circularly polarized light is dextrorotatory circularly polarized light, the phase does not change, and the traveling direction is reversed. Therefore, the sign of the phase difference between the components of light orthogonal to each other is reversed, and the reflected light is levorotatory circularly polarized light.

On the other hand, in a case of the optical laminate according to the first embodiment of the present invention, in which the relationship between Expression (3) and Expression (4) is satisfied, the relationship is that nv is small with respect to nmax and nv is large with respect to nmin. In a case of such a relationship between the refractive indices, in a case where light is incident from the outermost cholesteric liquid crystal layer side, the reflection occurring at the interface is free end reflection for the component in the direction indicating nmax of the outermost cholesteric liquid crystal layer and is fixed end reflection for the component in the direction indicating nmin of the outermost cholesteric liquid crystal layer. In this case, in the reflected light, the phase of the component in the direction indicating nmax of the outermost cholesteric liquid crystal layer is reversed from the incident light, and the phase of the component in the direction indicating nmin of the outermost cholesteric liquid crystal layer does not change from the incident light. In this case, in a case where the incident circularly polarized light is dextrorotatory circularly polarized light, the phase of one component changes, the phase of the other component orthogonal to one component does not change, and the traveling direction changes. Therefore, the sign of the phase difference between the components orthogonal to each other is not reversed, and the reflected light is dextrorotatory circularly polarized light.

In addition, by satisfying the relationship of Expression (5), the reflection of the component in the direction indicating nmax of the outermost cholesteric liquid crystal layer and the reflection of the component in the direction indicating nmin of the outermost cholesteric liquid crystal layer occur to the same extent, and the reflected light in a case where dextrorotatory circularly polarized light is incident is likely to be dextrorotatory circularly polarized light.

According to the above-described principle, in a case where the polarization direction of the incident circularly polarized light and the polarization direction of the reflected light match each other, leakage light is less likely to occur, and as a result, the occurrence of ghost is suppressed.

Hereinafter, the configuration of the optical laminate according to the first embodiment of the present invention and the configuration that may be provided in the optical laminate will be described.

### [Selective Reflection Layer]

The optical laminate according to the first embodiment of the present invention includes a selective reflection layer. The selective reflection layer includes at least one cholesteric liquid crystal layer.

Hereinafter, the cholesteric liquid crystal layer included in the selective reflection layer will be described.

The cholesteric liquid crystal layer refers to a liquid crystal layer in which a liquid crystal compound is cholesterically aligned. The cholesteric alignment refers to alignment of a liquid crystal compound in a cholesteric liquid crystalline phase, and the cholesteric liquid crystal layer may be a layer in which the cholesteric alignment is maintained. Typically, a polymerizable liquid crystal compound having a polymerizable group is brought into an alignment state of a cholesteric liquid crystalline phase by a method such as adding a chiral agent, and then the polymerizable liquid crystal compound is polymerized and cured by ultraviolet irradiation, heating, or the like to form a layer having no fluidity, whereby the cholesteric liquid crystal layer can be formed.

The cholesteric liquid crystal layer is preferably a layer that is changed to a state where the alignment form is not changed by an external field, an external force, or the like. In the cholesteric liquid crystal layer, it is sufficient that the optical properties of the cholesteric liquid crystalline phase are maintained in the layer, and the liquid crystal compound in the cholesteric liquid crystal layer may not exhibit liquid crystallinity. For example, the molecular weight of the polymerizable liquid crystal compound may be increased by a curing reaction such that the liquid crystallinity thereof is lost.

A central wavelength λ of reflected light of the cholesteric liquid crystal layer depends on the number of helical pitches P (=helical period) of a helical structure in the cholesteric liquid crystalline phase, and is represented by a relationship of λ=n×P using an average refractive index n of the cholesteric liquid crystal layer. The central wavelength of reflected light of the cholesteric liquid crystal layer can be obtained as follows. In a case where a transmission spectrum of the cholesteric liquid crystal layer is measured from a normal direction of the cholesteric liquid crystal layer using a spectrophotometer, a spectrum having a peak where a transmittance decreases in a region near the central wavelength of reflected light is obtained. That is, a reflection spectrum having a peak where a reflectance increases in a region near the central wavelength of reflected light is obtained. Among the two wavelengths where the transmittance is ½ of the value of the highest peak, a value of a wavelength on a short wavelength side is represented by λ₁ (nm), a value of a wavelength on a long wavelength side is represented by λ₂ (nm), and the central wavelength λ of reflected light is obtained by the following expression.

$$λ = ( {λ}_{1} + {λ}_{2} ) / 2$$

In a case where λ₁ obtained by the above-described procedure is obtained by the same procedure for the reflection spectrum of the outermost cholesteric liquid crystal layer, λ₁ is λmin which is a half-value wavelength on the short wavelength side. In addition, in a case where λ₂ is obtained by the same procedure for the reflection spectrum of the outermost cholesteric liquid crystal layer, λ₂ is λmax which is a half-value wavelength on the long wavelength side.

A more specific procedure is described in Examples below.

The helical pitch of the cholesteric liquid crystalline phase changes depending on the type of a chiral agent used together with the liquid crystal compound and the addition concentration thereof, and a cholesteric liquid crystalline phase having a desired pitch can be obtained by adjusting any one or more of the type of the chiral agent and the addition concentration thereof. Regarding a helical turning direction and measuring method of the pitch, it is possible to use the method described on “Introduction to Liquid Crystal Chemistry Experiments” (edited by The Japanese Liquid Crystal Society, Sigma Press, published in 2007, page 46), and “Handbook of Liquid Crystals” (edited by the Editorial Committee of Handbook of Liquid Crystals, Maruzen, page 196). Specifically, the number of helical pitches P is measured by the method described in Examples.

By the above-described method, λmax and λmin described in Expression (1) and Expression (2) and P can be measured, and nmax and nmin can be obtained.

In the cholesteric liquid crystal layer, nmax obtained by Expression (1) is often 1.50 to 2.00 and may be 1.60 to 1.90.

In the cholesteric liquid crystal layer, nmin obtained by Expression (2) is often 1.35 to 1.75 and may be 1.45 to 1.65.

nmax has a value larger than nmin.

The liquid crystal compound contained in the cholesteric liquid crystal layer is not particularly limited, and examples thereof include a rod-like liquid crystal compound and a disk-like liquid crystal compound.

Examples of the rod-like liquid crystal compound include a known rod-like liquid crystal compound, and preferred examples thereof include a polymerizable rod-like liquid crystal compound having a polymerizable group. Examples of the rod-like liquid crystal compound include those described in claim 1 of JP1999-513019A (JP-H11-513019A) or paragraphs [0026] to [0098] of JP2005-289980A, which are not particularly limited.

It is also preferable to use a liquid crystal compound having high refractive index anisotropy Δn (high Δn) as the rod-like liquid crystal compound. Here, Δn is a difference between a refractive index in the slow axis direction and a refractive index in the fast axis direction.

In a case where the rod-like liquid crystal compound has high Δn characteristics, a high reflectance can be obtained even in a case where the number of turns of the helical structure of the cholesteric liquid crystalline phase is small, and thus desired reflection characteristics can be obtained even in a case of a thin film thickness. The magnitude of the retardation generated with respect to incident light obliquely tilted from the normal direction of the cholesteric liquid crystal layer can be reduced due to the thinning, and as a result, the ghost can be further reduced.

The liquid crystal compound having a high refractive index anisotropy Δn is not particularly limited, but the compounds shown in paragraphs to of WO2019/182129A as an example and compounds represented by General Formula (I) can be preferably used.

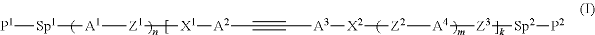

In General Formula (I), P¹ and P² each independently represent a hydrogen atom, —CN, —NCS, or a polymerizable group.

In General Formula (I), Sp¹ and Sp² each independently represent a single bond or a divalent linking group. However, Sp¹ and Sp² do not represent a divalent linking group including at least one group selected from the group consisting of an aromatic hydrocarbon ring group, an aromatic heterocyclic group, and an aliphatic hydrocarbon ring group.

In General Formula (I), Z¹, Z², and Z³ each independently represent a single bond, —O—, —S—, —CHR—, —CHRCHR—, —OCHR—, —CHRO—, —SO—, —SO₂—, —COO—, —OCO—, —CO—S—, —S—CO—, —O—CO—O—, —CO—NR—, —NR—CO—, —SCHR—, —CHRS—, —SO—CHR—, —CHR—SO—, —SO₂—CHR—, —CHR—SO₂—, —CF₂O—, —OCF₂—, —CF₂S—, —SCF₂—, —OCHRCHRO—, —SCHRCHRS—, —SO—CHRCHR—SO—, —SO₂—CHRCHR—SO₂—, —CH—CH—COO—, —CH═CH—OCO—, —COO—CH═CH—, —OCO—CH═CH—, —COO—CHRCHR—, —OCO—CHRCHR—, —CHRCHR—COO—, —CHRCHR—OCO—, —COO—CHR—, —OCO—CHR—, —CHR—COO—, —CHR—OCO—, —CR═CR—, —CR═N—, —N═CR—, —N═N—, —CR═N—N—CR—, —CF═CF—, or —C═C—. R represents a hydrogen atom or an alkyl group having 1 to 10 carbon atoms. In a case where a plurality of R's are present, R's may be the same or different from each other. In a case where a plurality of Z¹'s or a plurality of Z²'s are present, Z¹'s or Z²'s may be the same or different from each other. In a case where a plurality of Z³'s are present, Z³'s may be the same as or different from each other. Here, Z³ connected to Sp² represents a single bond.

In General Formula (I), X¹ and X² each independently represent a single bond or —S—. A plurality of X¹'s or a plurality of X²'s may be the same or different from each other. Here, among the plurality of X¹'s and a plurality of X²'s, at least one represents-S—.

In General Formula (I), k represents an integer of 2 to 4.

In General Formula (I), m and n each independently represent an integer of 0 to 3. A plurality of m's may be the same or different from each other.

In General Formula (I), A¹, A², A³, and A⁴ each independently represent a group represented by any one of General Formulae (B-1) to (B-7) or a group where two or three groups among the groups represented by General Formulae (B-1) to (B-7) are linked. A plurality of A²'s or a plurality of A³'s may be the same or different from each other. A plurality of A¹'s or a plurality of A⁴'s may be the same or different from each other.

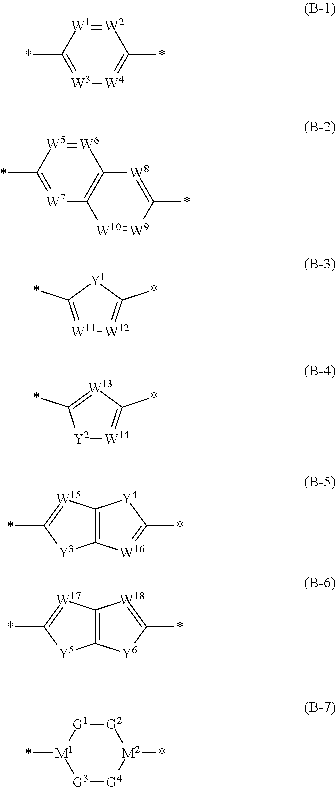

In General Formulae (B-1) to (B-7), W¹ to W¹⁸ each independently represent CR¹ or N, where R¹ represents a hydrogen atom or the following substituent L.

In General Formulae (B-1) to (B-7), Y¹ to Y⁶ each independently represent NR², O, or S, and R² represents a hydrogen atom or the following substituent L.

In General Formulae (B-1) to (B-7), G¹ to G⁴ each independently represent CR³R⁴, NR⁵, O, or S, and R³ to R⁵ each independently represent a hydrogen atom or the following substituent L.

In General Formulae (B-1) to (B-7), M¹ and M² each independently represent CR⁶ or N, and R⁶ represents a hydrogen atom or the following substituent L.

In General Formulae (B-1) to (B-7), * represents a bonding position.

The substituent L represents an alkyl group having 1 to 10 carbon atoms, an alkoxy group having 1 to 10 carbon atoms, an alkylamino group having 1 to 10 carbon atoms, an alkylthio group having 1 to 10 carbon atoms, an alkanoyl group having 1 to 10 carbon atoms, an alkanoyloxy group having 1 to 10 carbon atoms, an alkanoylamino group having 1 to 10 carbon atoms, an alkanoylthio group having 1 to 10 carbon atoms, an alkyloxycarbonyl group having 2 to 10 carbon atoms, an alkylaminocarbonyl group having 2 to 10 carbon atoms, an alkylthiocarbonyl group having 2 to 10 carbon atoms, a hydroxy group, an amino group, a mercapto group, a carboxy group, a sulfo group, an amide group, a cyano group, a nitro group, a halogen atom, or a polymerizable group. Here, in a case where the group described as the substituent L has —CH₂—, a group in which at least one —CH₂— in the group is substituted with —O—, —CO—, —CH═CH—, or —C═C— is also included in the substituent L. Here, in a case where the group described as the substituent L has a hydrogen atom, a group in which at least one hydrogen atom in the group is substituted with at least one selected from the group consisting of a fluorine atom and a polymerizable group is also included in the substituent L.

In order to further reduce the ghost, the refractive index anisotropy Δn₅₅₀ (refractive index anisotropy at a wavelength of 550 nm) of the liquid crystal compound is preferably 0.12 or more, more preferably 0.16 or more, still more preferably 0.20 or more, and most preferably 0.25 or more. From the viewpoint of suppressing interface reflection, the upper limit of Δn₅₅₀ (refractive index anisotropy at a wavelength of 550 nm) is preferably 0.90 or less, more preferably 0.70 or less, and most preferably 0.50 or less.

Examples of the disk-like liquid crystal compound include known disk-like liquid crystal compounds, and preferred examples thereof include polymerizable disk-like liquid crystal compounds having a polymerizable group. As examples of the disk-like liquid crystal compound, although not particularly limited, the disk-like liquid crystal compounds described in paragraphs to of JP2007-108732A can be suitably used.

In addition, it is also preferable to use a liquid crystal compound having high refractive index anisotropy Δn (high Δn) as the disk-like liquid crystal compound. Here, Δn is a difference between a refractive index in the slow axis direction and a refractive index in the fast axis direction.

In a case where the disk-like liquid crystal compound has high Δn characteristics, a high reflectance can be obtained even in a case where the number of turns of the helical structure of the cholesteric liquid crystalline phase is small, and thus desired reflection characteristics can be obtained even in a case of a thin film thickness. The magnitude of the retardation generated with respect to incident light obliquely tilted from the normal direction of the cholesteric liquid crystal layer can be reduced due to the thinning, and as a result, the ghost can be further reduced. As examples of the disk-like liquid crystal compound having a high Δn, the disk-like liquid crystal compounds described in paragraphs [0012] to [0108] of JP2010-244038A can be suitably used.

In order to further reduce the ghost, the refractive index anisotropy Δn₅₅₀ (refractive index anisotropy at a wavelength of 550 nm) of the liquid crystal compound is preferably 0.12 or more, more preferably 0.16 or more, still more preferably 0.20 or more, and most preferably 0.25 or more. From the viewpoint of suppressing interface reflection, the upper limit of Δn₅₅₀ (refractive index anisotropy at a wavelength of 550 nm) is preferably 0.90 or less, more preferably 0.70 or less, and most preferably 0.50 or less.

The polymerizable group that may be contained in the liquid crystal compound is not particularly limited, but is preferably a functional group capable of an addition polymerization reaction, more preferably a polymerizable ethylenically unsaturated group or a cyclic polymerizable group, and still more preferably a (meth)acryloyl group, a vinyl group, a styryl group, or an allyl group.

The number of polymerizable groups contained in the liquid crystal compound is not particularly limited, but is preferably 2 or more. The upper limit thereof is not particularly limited, and is often 10 or less.

The cholesteric liquid crystal layer is preferably a layer formed of a liquid crystal compound having a polymerizable group, and more preferably a layer obtained by immobilizing an alignment state of the liquid crystal compound having a polymerizable group.

The “fixed” state is the most typical and preferable aspect of a state in which the alignment of the liquid crystal compound is maintained. The “fixed” state is not limited thereto and is specifically more preferably a state in which, in a temperature range of usually 0° C. to 50° C. or in a temperature range of −30° C. to 70° C. under more severe conditions, the layer has no fluidity and a fixed alignment form can be maintained stably without causing a change in the alignment form due to an external field or an external force.

The selective reflection layer preferably has two or more cholesteric liquid crystal layers.

In a case where the selective reflection layer includes two or more cholesteric liquid crystal layers, it is preferable that the selective reflection layer includes a cholesteric liquid crystal layer R formed of a rod-like liquid crystal compound and a cholesteric liquid crystal layer D formed of a disk-like liquid crystal compound.

The cholesteric liquid crystal layer R is preferably a liquid crystal layer formed of a liquid crystal compound substantially consisting of a rod-like liquid crystal compound. The above-described “substantially consisting of a rod-like liquid crystal compound” means that the rod-like liquid crystal compound is 95% by mass or more of the liquid crystal compound contained in the cholesteric liquid crystal layer R.

Examples of the rod-like liquid crystal compound contained in the cholesteric liquid crystal layer R are as described above.

The cholesteric liquid crystal layer D is preferably a liquid crystal layer formed of a liquid crystal compound substantially consisting of a disk-like liquid crystal compound. The above-described “substantially consisting of a disk-like liquid crystal compound” means that the disk-like liquid crystal compound is 95% by mass or more of the liquid crystal compound contained in the cholesteric liquid crystal layer D.

Examples of the disk-like liquid crystal compound contained in the cholesteric liquid crystal layer D are as described above.

A thickness of the cholesteric liquid crystal layer R is preferably 0.1 μm or more, more preferably 0.2 μm or more, and still more preferably 0.3 μm or more. From the viewpoint that the ghost can be suppressed more, the thickness of the cholesteric liquid crystal layer R is preferably 10.0 μm or less, more preferably 7.0 μm or less, and still more preferably 5.0 μm or less.

The thickness of the cholesteric liquid crystal layer R can be measured by preparing a cross section of the optical laminate and observing the cross section with a scanning electron microscope. The thickness of the cholesteric liquid crystal layer R is a value obtained by averaging the thicknesses of the cholesteric liquid crystal layer R at any five points in the cross section of the optical laminate. In a case where the cross section of the optical laminate is observed with a scanning electron microscope, a region of the cholesteric liquid crystal layer R and a region of the cholesteric liquid crystal layer D, which will be described later, can be distinguished from each other by a difference in contrast of the observed image. In addition, the cholesteric liquid crystal layer R and the cholesteric liquid crystal layer D can be distinguished from each other by using a composition analysis in a film thickness direction by time-of-flight secondary ion mass spectrometry (TOF-SIMS).

The Rth of the cholesteric liquid crystal layer R is preferably 8 to 800 nm, more preferably 16 to 560 nm, and still more preferably 24 to 400 nm at a wavelength of 550 nm.

The Rth of the cholesteric liquid crystal layer R may be measured by extracting only the cholesteric liquid crystal layer R from the optical laminate, or the Rth of a layer produced under the same conditions as those in a case of producing the cholesteric liquid crystal layer R may be measured.

A thickness of the cholesteric liquid crystal layer D is preferably 0.1 μm or more, more preferably 0.2 μm or more, and still more preferably 0.3 μm or more. From the viewpoint that the ghost can be suppressed more, the thickness of the cholesteric liquid crystal layer D is preferably 10.0 μm or less, more preferably 7.0 μm or less, and still more preferably 5.0 μm or less.

The thickness of the cholesteric liquid crystal layer D can be measured in the same manner as the thickness of the cholesteric liquid crystal layer R.

The Rth of the cholesteric liquid crystal layer D is preferably −8 to −800 nm, more preferably −16 to −560 nm, and still more preferably −24 to −400 nm at a wavelength of 550 nm.

The Rth of the cholesteric liquid crystal layer D may be measured by extracting only the cholesteric liquid crystal layer D from the optical laminate, or the Rth of a layer produced under the same conditions as those in a case of producing the cholesteric liquid crystal layer D may be measured.

In addition, the number of helical pitches P of the cholesteric liquid crystalline phase of the cholesteric liquid crystal layer R or the cholesteric liquid crystal layer D may vary in the film thickness direction. A state where the number of helical pitches P varies in the film thickness direction is referred to as a pitch gradient, and a layer where the number of helical pitches P varies in the film thickness direction is referred to as a pitch gradient layer. The pitch gradient layer can be produced using a known method, and for example, JP2020-060627A and the like can be referred to.

In the pitch gradient layer, since the helical pitch changes in the film thickness direction, light in a plurality of wavelength ranges can be reflected.

In a case where the outermost cholesteric liquid crystal layer is a pitch gradient layer, a cholesteric liquid crystal layer in a region of 2.0 μm from the surface of the outermost cholesteric liquid crystal layer on the first adjacent layer side is obtained, a cross-sectional SEM observation is performed, and the helical pitch is measured from the stripe pattern of bright lines and dark lines appearing in the observed image. Here, the distance of bright-dark-bright-dark-bright of the stripe pattern corresponds to one turn of the helix. Furthermore, a reflection spectrum of the outermost cholesteric liquid crystal layer is acquired.

Next, the cholesteric liquid crystal is modeled using a Berreman 4×4 matrix method, and the reflection spectrum is calculated based on the helical pitch obtained by the above-described method, the temporary nmax, and nmin. A combination of nmax and nmin in which the reflection spectrum obtained by the calculation and the actually measured reflection spectrum match is searched for, and nmax and nmin having the highest match ratio are obtained.

The number of cholesteric liquid crystal layers included in the selective reflection layer may be 3 or more, 4 or more, 6 or more, or 8 or more. In addition, the number of cholesteric liquid crystal layers included in the selective reflection layer is preferably 120 or less, preferably 80 or less, and preferably 40 or less.

The central wavelengths λ of the reflected light of the cholesteric liquid crystal layers included in the selective reflection layer may be different from each other, partially the same, or all the same.

In a case where cholesteric liquid crystal layers having different central wavelengths λ of reflected light are laminated, light in a wavelength range corresponding to the central wavelength λ of each cholesteric liquid crystal layer can be reflected as a whole of the selective reflection layer.

For example, in a case where the optical laminate according to the first embodiment is applied to a head-mounted display described later, it is preferable to adjust the helical pitch number P of the cholesteric liquid crystal layer and adjust the central wavelength λ of the reflected light such that the wavelength of light emitted from the display panel is reflected.

More specifically, it is preferable that the cholesteric liquid crystal layer included in the selective reflection layer includes a blue light reflective layer, a green light reflective layer, a yellow light reflective layer, and a red light reflective layer, which will be described later.

The central wavelength of the reflected light of the blue light reflective layer is preferably in a range of 430 nm or more and less than 500 nm.

The central wavelength of the reflected light of the green light reflective layer is preferably in a range of 500 nm or more and less than 570 nm.

The central wavelength of the reflected light of the yellow light reflective layer is preferably in a range of 570 nm or more and less than 620 nm.

The central wavelength of the reflected light of the red light reflective layer is preferably in a range of 620 nm or more and less than 670 nm.

A method of measuring the central wavelength of the reflected light is as described above.

In the optical laminate according to the first embodiment of the present invention, the central wavelength of the reflected light of the cholesteric liquid crystal layer included in the optical laminate may be adjusted such that the reflectance is 40% or more over the entire visible light region (wavelength of 450 to 650 nm).

In addition, it is also preferable that the blue light reflective layer, the green light reflective layer, the yellow light reflective layer, and the red light reflective layer are laminated in this order from the first adjacent layer side in the selective reflection layer. In addition, in a case where the optical laminate having the above-described lamination order is applied to a reflective circular polarizer described later, in the reflective layer on the long wavelength side (for example, in the red light reflective layer), the thickness of the reflective layer required to obtain sufficient reflectance increases, and Rth of the reflective layer itself has a greater effect on light transmitted through the reflective layer. From this viewpoint, it is preferable that a reflective layer arranged on a light source side is the reflective layer on the short wavelength side (for example, the blue light reflective layer).

That is, it is preferable that the reflective layer on the short wavelength side (for example, the blue light reflective layer) is the outermost cholesteric liquid crystal layer.

In addition, in the optical laminate according to the first embodiment of the present invention, in a case where three or more cholesteric liquid crystal layers are provided, it is preferable that the cholesteric liquid crystal layer R and the cholesteric liquid crystal layer D are alternately laminated. This is because the cholesteric liquid crystal layer R often has a positive Rth, whereas the cholesteric liquid crystal layer D often has a negative Rth, and thus the Rths cancel each other out, and the occurrence of ghost is more easily reduced. Hereinafter, the details will be described.

In an optical laminate including n reflective layers, in a case where the reflective layers are named L₁, L₂, L₃, . . . , and Lₙ (n is an integer of 4 or more) from a light source side, the sum of Rth of each layer from the reflective layer L₁ to the reflective layer L₁ (i is an integer of n or less) is denoted by SRthᵢ. Specifically, the SRthᵢ is expressed as follows.

$${SRth}_{1} = {Rth}_{1}$$

$${SRth}_{2} = {Rth}_{1} + {Rth}_{2}$$

$$…$$

$${SRth}_{i} = {Rth}_{1} + {Rth}_{2} + ⋯ + {Rth}_{i}$$

$$…$$

$${SRth}_{n} = {Rth}_{1} + {Rth}_{2} + ⋯ + {Rth}_{i} + ⋯ + {Rth}_{n}$$

Absolute values of all of SRthᵢ (SRth₁ to SRthₙ) are each preferably 0.3 μm or less, more preferably 0.2 μm or less, and still more preferably 0.1 μm or less. The Rthᵢ of each layer in the above-described expression is determined by the expression for calculating Rth described above.

It is considered that, by setting the SRthᵢ to be within the above-described preferred range, a retardation which occurs in a case where light is transmitted through each reflective layer can be reduced, and the occurrence of the ghost can be further suppressed even for incident ray from an oblique direction.

In a case where the selective reflection layer includes two or more cholesteric liquid crystal layers, a layer other than the cholesteric liquid crystal layer may be provided between the two cholesteric liquid crystal layers. In addition, a layer other than the cholesteric liquid crystal layer may be provided on a side of the selective reflection layer opposite to the first adjacent layer.

The layer other than the cholesteric liquid crystal layer is not particularly limited, and examples thereof include an adhesion layer (for example, an adhesive layer or a pressure sensitive adhesive layer), a refractive index-adjusting layer, a resin film, a positive C-plate, and an alignment layer.

In addition, in a case where the selective reflection layer includes the cholesteric liquid crystal layer R and the cholesteric liquid crystal layer D, in order to reduce the difference in refractive index, it is preferable that the cholesteric liquid crystal layer R and the cholesteric liquid crystal layer D are disposed such that the alignment direction (slow axis direction) of the liquid crystal compound (rod-like liquid crystal compound or disk-like liquid crystal compound) continuously changes at the interface. For example, in a case where the cholesteric liquid crystal layer R is formed on the cholesteric liquid crystal layer D, the above-described disposition can be achieved by directly coating the cholesteric liquid crystal layer D with a coating liquid containing a rod-like liquid crystal compound and aligning the rod-like liquid crystal compound such that the slow axis direction is continuous at the interface by an orientation restriction force of the disk-like liquid crystal compound contained in the cholesteric liquid crystal layer D.

The thickness of the selective reflection layer is preferably 0.2 μm or more, more preferably 0.4 μm or more, and still more preferably 0.6 μm or more. In addition, the thickness of the selective reflection layer is preferably 20.0 μm or less, more preferably 14.0 μm or less, and still more preferably 10.0 μm or less.

### [First Adjacent Layer]

The optical laminate according to the first embodiment of the present invention includes a first adjacent layer selected from the group consisting of an optically isotropic layer and a C-plate. The first adjacent layer is disposed adjacent to the outermost cholesteric liquid crystal layer disposed on the outermost side of the selective reflection layer.

In addition, the first adjacent layer satisfies the relationships of the above-described expressions (3) to (5) with respect to the refractive index n1 on the outermost cholesteric liquid crystal layer side.

Hereinafter, the optically isotropic layer and the C-plate will be described.

### (Optically Isotropic Layer)

The optically isotropic layer refers to an optically isotropic layer.

Being optically isotropic in the in-plane direction refers to a layer in which the above-described in-plane retardation (Re) is 5 nm or less and the thickness direction retardation (Rth) is-5 to 5 nm. In the optically isotropic layer, Re may be 0 nm, and Rth may be 0 nm.

The thickness of the optically isotropic layer is preferably 50 nm or more, preferably 100 nm or more, and more preferably 200 nm or more. In a case where the thickness is equal to or more than the above-described thickness, the optically isotropic layer is likely to act optically, and the occurrence of ghost is more easily suppressed. In addition, from the viewpoint of forming the optically isotropic layer, the thickness of the optically isotropic layer is preferably 10 μm or less, preferably 5 μm or less, and more preferably 3 μm or less.

The material constituting the optically isotropic layer is not particularly limited, and examples thereof include an adhesive layer, a pressure sensitive adhesive layer, a hard coat layer, and an alignment layer (a layer having a liquid crystal alignment capability, and preferably, a photo-alignment layer). Hereinafter, each layer will be described.

The adhesive layer is not particularly limited as long as the requirements regarding n1 are satisfied, and a known adhesive can be used. As the adhesive, for example, an epoxy resin-based adhesive and an acrylic resin-based adhesive can be used.

The pressure sensitive adhesive layer is not particularly limited as long as the requirements regarding n1 are satisfied, and a known pressure sensitive adhesive can be used.

The refractive index (n1) of the adhesive and the pressure sensitive adhesive can be adjusted by mixing inorganic oxide fine particles (for example, fine particles of silicon oxide, fine particles of titanium oxide, and fine particles of zirconia).

A method of forming the adhesive layer and the pressure sensitive adhesive layer is not particularly limited, and examples thereof include a method of preparing a composition containing a component forming the adhesive layer or the pressure sensitive adhesive layer and a solvent, applying the composition onto the outermost cholesteric liquid crystal layer to form a coating layer, and removing the solvent from the coating layer. In addition, the adhesive layer and the pressure sensitive adhesive layer may be formed on another substrate and transferred to be adjacent to the outermost cholesteric liquid crystal layer.

The hard coat layer is not particularly limited as long as the above-described requirements for n1 are satisfied, and a known hard coat layer can be used.

Examples of a method of forming the hard coat layer include a method of forming a coating layer by coating the outermost cholesteric liquid crystal layer with a curable composition containing a crosslinkable monomer and curing the formed coating layer to form a hard coat layer.

Examples of the crosslinkable monomer contained in the curable composition include a monomer having a crosslinkable group. The crosslinkable group is not particularly limited, and examples thereof include a radically polymerizable group and a cationically polymerizable group.

The radically polymerizable group is not particularly limited, and examples thereof include a vinyl group, a butadiene group, a (meth)acryloyl group, a (meth)acrylamide group, a vinyl acetate group, a fumaric acid ester group, a styryl group, a vinylpyrrolidone group, and a maleimide group, where a (meth)acryl group is preferable. The (meth)acryloyl group represents a concept including an acryloyl group and a methacryloyl group.

The cationically polymerizable group is not particularly limited, and examples thereof include a vinyl ether group, an epoxy group, and an oxetanyl group.

The monomer having a crosslinkable group may be used alone or in combination of two or more kinds thereof.

In addition, the curable composition may contain the polymerization initiator. As the polymerization initiator, a known polymerization initiator such as a photopolymerization initiator and a thermal polymerization initiator can be applied.

The refractive index of the hard coat layer can be adjusted by, for example, the refractive index of the crosslinkable monomer contained in the curable composition. For example, by using a crosslinkable monomer having an aromatic ring or the like in the molecule as the crosslinkable monomer, the refractive index of the hard coat layer can be increased. On the other hand, by using a crosslinkable monomer having no aromatic ring or the like in the molecule as the crosslinkable monomer, the refractive index of the hard coat layer can be reduced.

In addition, the refractive index of the hard coat layer can be adjusted by mixing the curable composition with inorganic oxide fine particles.

The photo-alignment layer is not particularly limited as long as the photo-alignment layer satisfies the requirements regarding n1, and a known photo-alignment layer can be used.

Examples of the photo-alignment material used for a photo-alignment film include the azo compounds described in JP2006-285197A, JP2007-076839A, JP2007-138138A, JP2007-094071A, JP2007-121721A, JP2007-140465A, JP2007-156439A, JP2007-133184A, JP2009-109831A, JP3883848B, and JP4151746B, the aromatic ester compounds described in JP2002-229039A, the maleimide and/or alkenyl-substituted nadimide compounds having photo-alignment units described in JP2002-265541A and JP2002-317013A, the photocrosslinkable silane derivatives described in JP4205195B and JP4205198B, the photocrosslinkable polyimides, polyamides, and esters described in JP2003-520878A, JP2004-529220A, and JP4162850B, and the photodimerizable compounds, in particular, a cinnamate compound, a chalcone compound, and a coumarin compound, described in JP1997-118717A (JP-H09-118717A), JP1998-506420A (JP-H10-506420A), JP2003-505561A, WO2010/150748A, JP2013-177561A, and JP2014-012823A. Preferred examples of the photo-alignment material include an azo compound, a photo-crosslinking polyimide, a polyamide, an ester, a cinnamate compound, and a chalcone compound.

The photo-alignment layer can be formed by applying a composition containing the above-described photo-alignment material to form a coating film, irradiating the coating film with light, and applying an orientation restriction force. It is noted that it is preferable that the coating film is irradiated with polarized light in a direction perpendicular to the surface of the coating film or in a direction tilted from the perpendicular direction. In addition, the coating film may be irradiated with non-polarized light in a direction tilted from the direction perpendicular to the surface of the coating film.

It is noted that the composition containing the above-described photo-alignment material may contain a component other than the photo-alignment material that can form a photo-alignment layer.

The refractive index of the photo-alignment layer can be adjusted depending on the type of the above-described photo-alignment material. In addition, the refractive index of the photo-alignment layer can be adjusted by other components that may be contained together with the above-described photo-alignment material.

It is noted that the photo-alignment layer is a layer having a liquid crystal alignment capability (an alignment imparting ability to a liquid crystal compound).

### (C-Plate)

The C-plate refers to a layer in which Re is 5 nm or less and Rth is less than −5 nm or more than 5 nm. Hereinafter, a C-plate in which Rth is less than −5 nm is referred to as a positive C-plate, and a C-plate in which Rth is more than 5 nm is also referred to as a negative C-plate.

Rth of the C-plate is preferably less than −5 nm. That is, the C-plate is preferably a positive C-plate.

The positive C-plate can be obtained, for example, by vertically aligning rod-like liquid crystal compounds. With regard to the details of the method for manufacturing the positive C-plate, reference can be made to the description in, for example, JP2017-187732A, JP2016-053709A, JP2015-200861A, and the like.

Rth of the positive C-plate is preferably −100 nm or more and less than −5 nm, and more preferably −30 nm or more and less than −5 nm.

In addition, the positive C-plate can also be formed from a composition including a rod-like liquid crystal compound and the above-described photo-alignment material. In a case where the positive C-plate includes the photo-alignment material, the positive C-plate is a layer having a liquid crystal alignment capability.

In addition, depending on the type of the photo-alignment material, a layer to be formed may correspond to the positive C-plate even in a case where the rod-like liquid crystal compound is not included. Examples of the photo-alignment material are as described above.

It is also preferable that the refractive index of the first adjacent layer changes from a surface on the outermost cholesteric liquid crystal layer side toward a surface on a side opposite to the outermost cholesteric liquid crystal layer side. That is, it is preferable that the refractive index of the first adjacent layer changes in the thickness direction of the first adjacent layer. For example, the refractive index of the first adjacent layer may gradually increase or gradually decrease in the thickness direction of the first adjacent layer.

The change in refractive index may be continuous or stepwise. In addition, the change in refractive index may be present in a region where the refractive index changes in the thickness direction of the first adjacent layer, and the refractive index may not change over the entire thickness direction of the first adjacent layer.

It is preferable that a rate of change in refractive index in the region where the refractive index changes is low. Specifically, in the region where the refractive index changes, the rate of change in refractive index is preferably 1.4 μm⁻¹ or less, more preferably 0.7 μm⁻¹ or less, and still more preferably 0.3 μm⁻¹ or less. Examples of the lower limit of the rate of change in refractive index include 0.01 μm⁻¹ or more.

The rate of change in refractive index is obtained by dividing the amount of change in refractive index by the length in the thickness direction of the region where the refractive index changes.

Examples of the method of forming the hard coat layer as the first adjacent layer where the refractive index changes in the thickness direction include a method of sequentially forming hard coat layers having different refractive indices. Specifically, examples thereof include a method of forming a first hard coat layer satisfying the requirement regarding n1 and then forming a second hard coat layer having a lower refractive index than n1 on the first hard coat layer. The method of adjusting the refractive index is as described above.

A hard coat layer having a lower refractive index than the second hard coat layer may be sequentially formed on the second hard coat layer.

In addition, a composition containing two or more kinds of compounds having different surface energies and refractive indices may be applied to form a coating film, the coating film may be dried to segregate the compound having a lower surface energy to the air interface side, and a first adjacent layer where the refractive index changes in the thickness direction may be formed.

The refractive index n1 of the first adjacent layer on the outermost cholesteric liquid crystal layer side satisfies the relationships of the above expressions (3) to (5), and n1 is, for example, preferably 1.42 to 1.83 and more preferably 1.52 to 1.73.

### [Second Adjacent Layer]

The optical laminate according to the first embodiment of the present invention may further include a second adjacent layer different from the first adjacent layer. The second adjacent layer is disposed adjacent to the first adjacent layer on a side opposite to the selective reflection layer side.

In addition, in a case where the optical laminate according to the first embodiment of the present invention includes the second adjacent layer, it is preferable that a refractive index n2 of the first adjacent layer on a second adjacent layer side and a refractive index n3 of the second adjacent layer on a first adjacent layer side satisfy a relationship of Expression (6).

$$\vert n 3 - n 2 \vert \leq 0.03 \qquad Expression ( 6 )$$

The left side of the expression (6) represents an absolute value of a value obtained by subtracting the value of n2 from the value of n3.

In a case where the optical laminate according to the first embodiment of the present invention has the second adjacent layer and satisfies the relationship of the expression (6), a difference in refractive index at an interface between the first adjacent layer and the second adjacent layer is reduced, and thus light reflection is less likely to occur at the interface, and the occurrence of ghost can be further suppressed.

In a case where the optical laminate according to the first embodiment of the present invention has the second adjacent layer, it is also preferable to change the refractive index of the first adjacent layer in the thickness direction so as to satisfy the requirement of the expression (6).

Examples of the second adjacent layer include the same aspects as those of the first adjacent layer.

Among these, the second adjacent layer is preferably an optically isotropic layer (more preferably, a pressure sensitive adhesive layer or an adhesive layer). Since the aspect of the optically isotropic layer is as described in the first adjacent layer, the description thereof will be omitted.

It is preferable to adjust the refractive index of the second adjacent layer to satisfy the expression (6) by the above-described method of adjusting the refractive index.

In the optical laminate according to the first embodiment of the present invention, a reflectance of light having a wavelength of 450 to 650 nm is preferably 40% or more, more preferably 42% or more, and still more preferably 45% or more. In addition, the reflectance is preferably less than 50%.

The reflectance can be achieved, for example, by adjusting the reflection characteristics of the selective reflection layer.

### [Optical Laminate According to Second Embodiment]

The optical laminate according to the second embodiment of the present invention includes a reflective type linear polarizer, a retardation layer, and a first adjacent layer selected from the group consisting of an optically isotropic layer disposed adjacent to the retardation layer and a C-plate. The first adjacent layer is disposed on a side of the retardation layer opposite to the reflective type linear polarizer.

FIG. 2 is a schematic cross-sectional view of the optical laminate according to the second embodiment of the present invention.

An optical laminate 30 according to the aspect shown in FIG. 2 includes an optically isotropic layer 32, a λ/4 plate 42, and a reflective type linear polarizer 44 in this order. The optically isotropic layer 32 is adjacent to the λ/4 plate 42. That is, the optically isotropic layer 32 corresponds to the first adjacent layer.

As will be described later, the optical laminate according to the second embodiment of the present invention is not limited to the aspect shown in FIG. 2, and various modifications can be made.

Here, in the optical laminate according to the second embodiment of the present invention, in a case where a refractive index of the retardation layer (λ/4 plate 42 in FIG. 2) in an in-plane slow axis direction is denoted by nx1, a refractive index of the retardation layer in an in-plane fast axis direction is denoted by ny1, and a refractive index of the first adjacent layer (optically isotropic layer 32 in FIG. 2) on the retardation layer side is denoted by n4, relationships of Expression (7) to Expression (9) are satisfied.

$$nx 1 > n 4 \qquad Expression ( 7 )$$

$$ny 1 < n 4 \qquad Expression ( 8 )$$

$$\vert {( nx 1 \cdot ny 1 )}^{1 / 2} - n 4 \vert \leq 0.03 \qquad Expression ( 9 )$$

That is, in the optical laminate according to the second embodiment of the present invention, nx1 is larger than n4 (Expression (7)), and ny1 is smaller than n4 (Expression (8)) between nx1 and ny1 corresponding to the refractive index of the retardation layer and n4 which is the refractive index of the first adjacent layer on the retardation layer side. In addition, an absolute value of a difference between a geometric mean value of nx1 and ny1 corresponding to the refractive index of the retardation layer and n4 which is the refractive index of the first adjacent layer is 0.03 or less (Expression (9)).

In the optical laminate according to the second embodiment of the present invention, in a case where the relationships of Expression (7) to Expression (9) are satisfied, a mechanism in which a ghost is less likely to occur in a case of being applied to a head-mounted display is not always clear, but the present inventors suppose as follows.

In a case where the optical laminate according to the second embodiment of the present invention is applied to a head-mounted display, as will be described in detail later, a ray is reflected by a reflective type linear polarizer in the optical laminate to reciprocate the ray, and a virtual image is visually recognized by an observer. In the optical laminate according to the second embodiment of the present invention, since the optical laminate has a characteristic of reflecting circularly polarized light by the reflective type linear polarizer and the retardation layer (for example, the λ/4 plate), the optical laminate has a function of selectively reflecting the circularly polarized light without changing a polarization direction of the circularly polarized light. In many cases, circularly polarized light is incident into an interface between the retardation layer and the first adjacent layer.

Here, in the optical laminate, reflection may occur at an interface between members having a difference in refractive index. In the optical laminate according to the second embodiment of the present invention, there is a possibility that unintended reflection occurs due to a difference in refractive index at an interface between the retardation layer and the first adjacent layer. In a case where unintended reflection occurs, an image is observed at an unintended position, and a ghost occurs. In particular, in a case where the polarization direction of circularly polarized light generated by unintended reflection is changed, in a case where the circularly polarized light is converted into linearly polarized light by the retardation layer, the polarization direction of the linearly polarized light is a direction orthogonal to each other between dextrorotatory circularly polarized light and levorotatory circularly polarized light. Therefore, the light is not absorbed by the absorptive linear polarizer or the like, leakage light occurs, and the occurrence of a ghost is likely to occur.

In the optical laminate according to the second embodiment of the present invention, the relationships of Expression (7) to Expression (9) are satisfied for the refractive index of the retardation layer (the refractive index nx1 in the in-plane slow axis direction and the refractive index ny1 in the in-plane fast axis direction) and the refractive index n4 of the first adjacent layer on the retardation layer side.

In this case, it is considered that the polarization direction of the incident light and the polarization direction of the reflected light are likely to coincide with each other for the reflection of circularly polarized light occurring at the interface between the retardation layer and the first adjacent layer, according to the same principle as the optical laminate according to the first embodiment of the present invention. In this case, leakage light is less likely to occur, and as a result, the occurrence of a ghost is suppressed.

Hereinafter, the configuration of the optical laminate according to the second embodiment of the present invention and the configuration that may be provided in the optical laminate will be described.

### [Reflective Type Linear Polarizer]

The optical laminate according to the second embodiment of the present invention includes a reflective type linear polarizer.

The reflective type linear polarizer is a linear polarizer which transmits linearly polarized light in a certain direction (transmission axis direction) and reflects linearly polarized light in a direction (reflection axis direction) orthogonal to the linearly polarized light.

The reflective type polarizer is preferably a polarizer which selectively transmits linearly polarized light in a certain direction in a wavelength range of visible light, and a known reflective type linear polarizer can be used.

Examples of the reflective type linear polarizer include a stretched film of a dielectric multi-layer film as described in JP2011-053705A and the like.

In addition, as the reflective linear polarizer, a commercially available product can be suitably used. Examples of the commercially available reflective type linear polarizer include a reflective type linear polarizer (trade name: APF) manufactured by 3M.

In addition, examples of the reflective type linear polarizer also include a wire grid polarizer.

A known wire grid polarizer can be applied as the wire grid polarizer, and a commercially available product may be used.

### [Retardation Layer]

The optical laminate according to the second embodiment of the present invention includes a retardation layer.

The retardation layer refers to a layer having an in-plane retardation (Re). It is preferable that the retardation layer has a value of Re of λ/4 (or an odd multiple thereof) at a predetermined wavelength of 2 nm.

The Re of the retardation layer at a wavelength of 550 nm may have an error of about 25 nm with an ideal value (137.5 nm) as a center, and is, for example, preferably 110 to 160 nm and more preferably 120 to 150 nm.

A refractive index nx1 of the retardation layer in an in-plane slow axis direction and a refractive index ny1 of the retardation layer in an in-plane fast axis direction are obtained by obtaining a reflection spectrum in a case where linearly polarized light is incident on the retardation layer with a spectrophotometer and calculating the refractive index from the reflectance. Specifically, the measurement is performed by a method described in Examples later.

The refractive index nx1 in the in-plane slow axis direction is often 1.40 to 1.80, and may be 1.50 to 1.70.

The refractive index ny1 in the in-plane fast axis direction is often 1.35 to 1.75, and may be 1.45 to 1.65.

nx1 has a value larger than ny1.

It is more preferable that the retardation layer exhibits characteristics of a λ/4 plate at each wavelength in a visible light region, and such a retardation layer is particularly referred to as a broadband λ/4 plate. In the broadband λ/4 plate, it is preferable that an in-plane retardation (Re(λ)) at a wavelength of λ nm satisfies Expressions (A) and (B).

$$Re ( 450 ) / Re ( 550 ) < 1. \qquad Expression ( A )$$

$$Re ( 65 \; 0 ) / Re ( 550 ) \geq 1. \qquad Expression ( B )$$

Re (450) represents an in-plane retardation of the λ/4 plate at a wavelength of 450 nm, Re (550) represents an in-plane retardation of the λ/4 plate at a wavelength of 550 nm, and Re (650) represents an in-plane retardation of the λ/4 plate at a wavelength of 650 nm.

The retardation layer used in the second embodiment of the present invention may be configured with a single layer of a retardation layer, or may be configured by laminating two or more layers of retardation layers by a method such as bonding or sequential formation. The retardation layer described herein is a layer exhibiting optical anisotropy. Examples of the retardation layer include a layer in which at least two of nx, ny, or nz are different. nx represents a refractive index in a direction (slow axis direction) that is perpendicular to a thickness direction of the retardation layer (in-plane direction) and provides a maximum refractive index. ny represents a refractive index in a direction (fast axis direction) that is an in-plane direction of the retardation layer and is orthogonal to the direction of nx. nz represents a refractive index in a thickness direction of the retardation layer.

A material constituting the retardation layer used in the second embodiment of the present invention is not particularly limited, and examples thereof include a liquid crystal compound and a polymer. By aligning the liquid crystal material to exhibit refractive index anisotropy, the liquid crystal compound can form a retardation layer. The polymer can form a retardation layer by exhibiting refractive index anisotropy by stretching or the like of a polymer film obtained by casting or coating. The retardation layer in the second embodiment of the present invention is preferably a layer formed of a liquid crystal compound, and more preferably a layer formed of a liquid crystal compound having a polymerizable group. That is, the retardation layer according to the embodiment of the present invention preferably contains a liquid crystal compound.

The liquid crystal compound used in the retardation layer is preferably a liquid crystal compound having a polymerizable group. Examples of the liquid crystal compound are the same as the examples of the liquid crystal compound described in the first embodiment.

The liquid crystal compound may be a liquid crystal compound exhibiting any of forward wavelength dispersibility or reverse wavelength dispersibility. In a case where a retardation layer exhibiting characteristics of a broadband λ/4 plate is used as a single film, a liquid crystal compound exhibiting reverse wavelength dispersibility is preferable, and a liquid crystal compound having two or more polymerizable groups and exhibiting reverse wavelength dispersibility is more preferable.

In the present specification, the “liquid crystal compound exhibiting reverse wavelength dispersibility” refers to a compound in which, in a case where an in-plane retardation (Re) value at a specific wavelength (visible light range) of an optically anisotropic layer produced using the compound is measured, the above-described relationships of Expression (A) and Expression (B) are satisfied.

In addition, in the present specification, the “liquid crystal compound exhibiting forward wavelength dispersibility” refers to a compound in which, in a case where an in-plane retardation (Re) value at a specific wavelength (visible light range) of a retardation layer produced using the compound is measured, a relationship between Expression (C) and Expression (D) is satisfied.

$$Re ( 450 ) / Re ( 5 \; 50 ) \geq 1. \qquad Expression ( C )$$

$$Re ( 650 ) / Re ( 550 ) < 1. \qquad Expression ( D )$$

As described above, the retardation layer is preferably a layer formed of a liquid crystal compound having a polymerizable group, and more preferably a layer formed by fixing an alignment state of a liquid crystal compound having a polymerizable group.

The alignment state that the liquid crystal compound having a polymerizable group can take is not particularly limited, and examples thereof include a homogeneous alignment, a homeotropic alignment, a twisted alignment, a cholesteric alignment, a hybrid alignment (alignment in which a tilt angle of the liquid crystal compound continuously changes from one surface to another surface), and a tilt alignment (alignment in which a tilt angle of the liquid crystal compound is constant from one surface to another surface). The twisted alignment represents an alignment state in which the liquid crystal compound is twisted with respect to the thickness direction as a rotation axis, and in a case where the liquid crystal compound is twisted and aligned and has a predetermined tilt angle (tilt angle is more than) 0°, the twisted alignment corresponds to a twisted hybrid alignment. In the present specification, the twisted alignment corresponds to an aspect in which the twisted angle of the liquid crystal compound is less than 360°, and the cholesteric alignment corresponds to an aspect in which the twisted angle of the liquid crystal compound is 360° or more.

The retardation layer formed of a liquid crystal compound may have a plurality of regions in which alignment states of the liquid crystal compound are different from each other along a thickness direction. For example, the retardation layer may have a region formed by fixing a state where the liquid crystal compound is homogeneously aligned and a region formed by fixing a state where the liquid crystal compound is twisted and aligned, along the thickness direction.

The thickness of the retardation layer is not particularly limited, but is preferably 0.1 to 10.0 μm and more preferably 0.5 to 5.0 μm.

Specific examples of the configuration of the broadband λ/4 plate include, as a retardation layer formed of a single-layer retardation layer, a retardation layer formed of a liquid crystal compound exhibiting reverse wavelength dispersibility, which is disclosed in WO2019/160016A, JP2020-173460A, WO2021/157694A, and the like, and a retardation layer having a plurality of regions having different alignment states of a liquid crystal compound in a thickness direction, which is disclosed in WO2022/030308A, JP2022-184691A, and the like. In addition, examples of a retardation layer having a configuration in which two or more retardation layers are laminated include a configuration in which a λ/4 retardation layer and a λ/2 retardation layer disclosed in JP2001-108825A, JP2001-091741A, WO2013/137464A, and the like are combined, and a configuration in which a retardation layer having a twisted alignment and another retardation layer disclosed in JP2001-021720A, JP2014-209219A, WO2022/255105A, and the like are combined. In addition, in order to compensate for a change in phase difference with respect to obliquely incident light, another retardation layer such as a positive C-plate or a negative C-plate may be further added.

### [First Adjacent Layer]

The optical laminate according to the second embodiment of the present invention includes a first adjacent layer selected from the group consisting of an optically isotropic layer and a C-plate. The first adjacent layer is disposed adjacent to the above-described retardation layer.

In addition, the first adjacent layer satisfies the relationships of Expressions (7) to (9) with respect to a refractive index n4 on the retardation layer side.

Since the first adjacent layer included in the optical laminate according to the second embodiment of the present invention is the same as the first adjacent layer according to the first embodiment, the description thereof will be omitted.

However, the term “outermost cholesteric liquid crystal layer side” described in the first embodiment is read as “retardation layer side”, and the term “n1” is read as “n4”.

For example, it is also preferable that the first adjacent layer is a layer having a liquid crystal alignment capability. In addition, it is also preferable that the refractive index of the first adjacent layer changes from a surface on the reflective type linear polarizer side toward a surface on a side opposite to the reflective type linear polarizer side. That is, it is preferable that the refractive index of the first adjacent layer changes in the thickness direction of the first adjacent layer.

In addition, the refractive index n4 of the first adjacent layer included in the optical laminate according to the second embodiment on the retardation layer side satisfies the relationships of Expressions (7) to (9), and n4 is, for example, preferably 1.37 to 1.78 and more preferably 1.45 to 1.68.

### [Second Adjacent Layer]

The optical laminate according to the second embodiment of the present invention may further include a second adjacent layer different from the first adjacent layer. The second adjacent layer is disposed adjacent to the side of the first adjacent layer opposite to the reflective type linear polarizer side.

In addition, in a case where the optical laminate according to the second embodiment of the present invention includes the second adjacent layer, it is preferable that a refractive index n5 of the first adjacent layer on a second adjacent layer side and a refractive index n6 of the second adjacent layer on a first adjacent layer side satisfy a relationship of Expression (10).

$$\vert n 6 - n 5 \vert \leq 0.03 . \qquad Expression ( 10 )$$

The left side of Expression (10) represents an absolute value of a value obtained by subtracting the value of n5 from the value of n6.

In a case where the optical laminate according to the second embodiment of the present invention includes the second adjacent layer and satisfies the relationship of Expression (10), a difference in refractive index at an interface between the first adjacent layer and the second adjacent layer is reduced, and light is less likely to be reflected at the interface, so that the occurrence of ghost can be further suppressed.

In a case where the optical laminate according to the second embodiment of the present invention includes the second adjacent layer, it is also preferable to change the refractive index of the first adjacent layer in the thickness direction to satisfy the requirement of Expression (10).

Examples of the second adjacent layer include the same aspects as those of the first adjacent layer.

Among these, the second adjacent layer is preferably an optically isotropic layer (more preferably, a pressure sensitive adhesive layer or an adhesive layer). Since the aspect of the optically isotropic layer is as described in the first adjacent layer, the description thereof will be omitted.

It is preferable to adjust the refractive index of the second adjacent layer to satisfy Expression (10) by the above-described method of adjusting the refractive index.

In the optical laminate according to the second embodiment of the present invention, a reflectance of light having a wavelength of 450 to 650 nm is preferably 40% or more, more preferably 42% or more, and still more preferably 45% or more. In addition, the reflectance is preferably less than 50%.

The reflectance can be adjusted, for example, by selecting the type of the reflective type linear polarizer.

### [Laminated Optical Film]

The laminated optical film according to the embodiment of the present invention includes the optical laminate according to the first embodiment or the optical laminate according to the second embodiment.

Hereinafter, the laminated optical film according to the first embodiment and the laminated optical film according to the second embodiment will be described.

### [Laminated Optical Film According to First Embodiment]

The laminated optical film according to the first embodiment includes the optical laminate according to the first embodiment, a retardation layer, and a polarizer in this order. The retardation layer is disposed on a side of the selective reflection layer of the optical laminate opposite to the first adjacent layer.

Hereinafter, the configuration of the laminated optical film according to the first embodiment of the present invention and the configuration that may be included in the laminated optical film will be described.

### (Retardation Layer)

The retardation layer included in the laminated optical film according to the first embodiment is preferably a λ/4 plate. Since the preferred aspect of the λ/4 plate is the same as that of the retardation plate according to the second embodiment, the description thereof will be omitted.

### (Polarizer)

The polarizer included in the laminated optical film according to the first embodiment is preferably a linear polarizer, and more preferably an absorptive linear polarizer. The absorptive linear polarizer refers to a linear polarizer which absorbs linearly polarized light in an absorption axis direction of incident light and allows transmission of linearly polarized light in a transmission axis direction.

As the absorptive linear polarizer, a known absorptive linear polarizer can be applied, and for example, a polarizer in which a dichroic substance is dyed in polyvinyl alcohol or other polymer resins and aligned by stretching, or a polarizer in which a dichroic substance is aligned by using alignment of a liquid crystal compound may be used.

A thickness of the absorption type linear polarizer is preferably 10 μm or less, more preferably 7 μm or less, and still more preferably 5 μm or less. In a case where the absorption type linear polarizer is thin, cracks or breakage of the film can be prevented in a case where the laminated optical film is stretched or molded.

In addition, a single plate transmittance of the absorptive linear polarizer is preferably 40% or more and more preferably 42% or more. Moreover, the degree of polarization is preferably 90% or more, more preferably 95% or more, and still more preferably 99% or more. In the present invention, the single plate transmittance and the degree of polarization of the absorption type linear polarizer are measured using an automatic polarizing film measuring device: VAP-7070 (manufactured by Jasco Corporation).

In the laminated optical film according to the first embodiment, an angle between the transmission axis of the polarizer and the retardation layer is preferably 45°±10°, more preferably 45°±5°, and still more preferably 45°±3°.

In the laminated optical film according to the first embodiment, for example, in a case where the retardation layer is a λ/4 plate and the polarizer is an absorptive linear polarizer, it is possible to absorb circularly polarized light in a direction which is not reflected by the selective reflection layer among circularly polarized light incident into the selective reflection layer, and to transmit circularly polarized light in a direction opposite to a polarization direction of the circularly polarized light incident into the selective reflection layer.

As described above, it is also preferable that the polarizer used in the laminated optical film according to the first embodiment of the present invention is a light-absorbing anisotropic layer containing a liquid crystal compound and a dichroic substance. The linear polarizer containing a liquid crystal compound and a dichroic substance is preferable from the viewpoint that the thickness thereof can be reduced and cracks or breakage is unlikely to occur even in a case of being stretched or molded. The thickness of the light absorption anisotropic layer is not particularly limited, but is preferably in a range of 0.1 to 8 μm and more preferably in a range of 0.3 to 5 μm from the viewpoint of reducing the thickness.

The linear polarizer containing a liquid crystal compound and a dichroic substance can be produced with reference to, for example, JP2020-023153A. From the viewpoint of improving the polarization degree of the linear polarizer, the alignment degree of the dichroic substance in the light absorption anisotropic layer is preferably 0.95 or greater and more preferably 0.97 or greater.

A liquid crystal compound which does not exhibit dichroic properties in the visible region is preferable as a liquid crystal compound contained in a composition used for forming the light absorption anisotropic layer, which is used to form the light absorption anisotropic layer.

As such a liquid crystal compound, both a low-molecular-weight liquid crystal compound and a polymer liquid crystal compound can be used. Here, the “low-molecular-weight liquid crystal compound” refers to a liquid crystal compound having no repeating unit in the chemical structure. In addition, “polymer liquid crystal compound” refers to a liquid crystal compound including a repeating unit in a chemical structure.

Examples of the polymer liquid crystal compound include thermotropic liquid crystal polymers described in JP2011-237513A. In addition, it is preferable that the polymer liquid crystal compound has a crosslinkable group (such as an acryloyl group or a methacryloyl group) at a terminal.

The liquid crystal compound may be used alone or in combination of two or more kinds thereof. It is also preferable that the polymer liquid crystal compound and the low-molecular-weight liquid crystal compound are used in combination.

A content of the liquid crystal compound is preferably 25 to 2000 parts by mass, more preferably 33 to 1000 parts by mass, and still more preferably 50 to 500 parts by mass with respect to 100 parts by mass of a content of the dichroic substance in the present composition. In a case where the content of the liquid crystal compound is within the above-described range, the alignment degree of the polarizer is further improved.

The dichroic substance contained in the composition for forming the light absorption anisotropic layer, which is used to form the light absorption anisotropic layer, is not particularly limited, and examples thereof include a visible light absorbing substance (dichroic coloring agent), an ultraviolet absorbing substance, an infrared absorbing substance, a nonlinear optical substance, and a carbon nanotube. In addition, known dichroic substances (dichroic coloring agents) of the related art can be used.

In the laminated optical film according to the first embodiment of the present invention, two or more kinds of dichroic substances may be used in combination. For example, from the viewpoint of obtaining a high polarization degree in a wider wavelength range, it is preferable to use in combination at least one dichroic substance having a maximal absorption wavelength in a wavelength range of 370 to 550 nm and at least one dichroic substance having a maximal absorption wavelength in a wavelength range of 500 to 700 nm.

In a case where the polarizer used in the laminated optical film according to the first embodiment of the present invention consists of a light-absorbing anisotropic layer containing a liquid crystal compound and a dichroic substance, the polarizer may include a support, an alignment layer, and the like, but the support and the alignment layer may be a temporary support which is peeled off and removed in a case of producing the laminated optical film. It is preferable that a temporary support is used from the viewpoint that the thickness of the laminated optical film can be reduced by transferring the light absorption anisotropic layer to another laminate and peeling and removing the temporary support and the adverse effect of the retardation of the temporary support on the polarization degree of transmitted light can be eliminated.

The type of the support is not particularly limited, but it is preferable that the support is transparent to visible light, and for example, the same support as the support used in the above-described retardation layer can be used. Preferred aspects of the support used in the linear polarizer are the same as the preferred aspects of the support used in the above-described retardation layer.

In addition, it is preferable that the linear polarizer used in the laminated optical film according to the embodiment of the present invention is transparent to near-infrared light in order to minimize the influence on various sensors incorporated in optical systems such as a virtual reality display device and an electronic finder, in which near-infrared light for eye tracking, facial expression recognition, and iris recognition is used as a light source.

### (Other Functional Layers)

The laminated optical film according to the first embodiment of the present invention may have other functional layers in addition to the optical laminate, the retardation layer, and the polarizer according to the first embodiment.

In addition, it is preferable that the other functional layers are transparent to near-infrared light in order to minimize the influence on various sensors incorporated in optical systems such as a virtual reality display device and an electronic finder, in which near-infrared light for eye tracking, facial expression recognition, and iris recognition is used as a light source.

Hereinafter, the other functional layers will be described.

### <Positive C-Plate>

It is also preferable that the laminated optical film according to the first embodiment of the present invention further has a positive C-plate. Here, the definition of the positive C-plate is as described above. The positive C-plate can be obtained, for example, by vertically aligning rod-like liquid crystal compounds. With regard to the details of the method for manufacturing the positive C-plate, reference can be made to the description in, for example, JP2017-187732A, JP2016-053709A, JP2015-200861A, and the like.

The positive C-plate functions as an optical compensation layer for increasing the degree of polarization of the transmitted light with respect to light incident obliquely. A plurality of positive C-plates may be provided at any position of the laminated optical film.

The positive C-plate may be provided adjacent to the retardation layer or inside the retardation layer. For example, in a case where a layer formed by immobilizing a rod-like liquid crystal compound is used as the retardation layer, the retardation layer has a positive Rth. Here, in a case where light is incident on the retardation layer in an oblique direction, the polarization state of the transmitted light may change due to the action of the Rth, and the degree of polarization of the transmitted light may decrease. In a case where the positive C-plate is provided inside or in the vicinity of the retardation layer, the change in polarization state of the oblique incident light can be further suppressed, so that the decrease in polarization degree of the transmitted light can be further suppressed, and as a result, the ghost can be further suppressed, which is preferable. According to the studies of the present inventors, the positive C-plate is preferably disposed between the retardation layer and the side opposite to the polarizer side, but may be disposed between the retardation layer and the polarizer, or may be installed at other places. Re of the positive C-plate in this case is preferably approximately 10 nm or less, and Rth thereof is preferably −90 to −40 nm.

### <Antireflection Layer>

It is also preferable that the laminated optical film according to the first embodiment of the present invention includes an antireflection layer on the surface. The laminated optical film according to the first embodiment of the present invention has a function of reflecting specific circularly polarized light and transmitting circularly polarized light orthogonal to the specific circularly polarized light. On the other hand, reflection on the surface of the laminated optical film according to the first embodiment generally includes unintended reflection of polarized light, and thus the degree of polarization of transmitted light may be decreased. Therefore, it is preferable that the laminated optical film according to the first embodiment includes an antireflection layer on the surface. The antireflection layer may be installed only on one surface of the laminated optical film according to the first embodiment, or may be installed on both surfaces.

The type of the antireflection layer is not particularly limited, but from the viewpoint of further decreasing the reflectance, a moth-eye film or an anti-reflective (AR) film is preferable. As the moth-eye film and the AR film, known films can be used.

In addition, in a case where the laminated optical film is stretched or molded, the moth-eye film is preferable from the viewpoint that high antireflection performance can be maintained even in a case of fluctuation in the film thickness due to the stretching. Furthermore, in a case where the antireflection layer includes a support and stretching or molding is performed, from the viewpoint of facilitating the stretching or the molding, the above-described support has a Tg peak temperature of preferably 170° C. or lower and more preferably 130° C. or lower. Specifically, for example, a PMMA film or the like is preferable.

### <Second Retardation Layer>

It is also preferable that the laminated optical film according to the first embodiment of the present invention further includes a second retardation layer. For example, the laminated optical film may include a first adjacent layer, a selective reflection layer, a retardation layer, a polarizer, and a second retardation layer in this order.

It is preferable that the second retardation layer converts linearly polarized light into circularly polarized light, and for example, a retardation layer having Re of a ¼ wavelength is preferable. The reason for this will be described below.

Light incident on the laminated optical film from the first adjacent layer side and transmitted through the polarizer is linearly polarized light, and a part of the light is reflected from the outermost surface on the polarizer side and is emitted from the surface on the first adjacent layer side again. Such light is extra reflected light and may decrease the degree of polarization of the reflected light, and thus it is preferable that the amount of such light is reduced. Therefore, a method of laminating an antireflection layer may be considered to suppress reflection on the outermost surface on the side of the linear polarizer, but in a case where the laminated optical film is used by being bonded to a medium such as glass or plastic, the antireflection effect cannot be obtained because reflection on the surface of the medium cannot be suppressed even in a case where the antireflection layer is provided on the bonding surface of the laminated optical film.

Meanwhile, in a case where the second retardation layer which converts linearly polarized light into circularly polarized light is provided, light which reaches the outermost surface on the side of the linear polarizer is converted into circularly polarized light, and converted into circularly polarized light orthogonal thereto in a case of reflection on the outermost surface of the medium. Thereafter, in a case where the light is transmitted through the second retardation layer again and reaches the polarizer, the light is linearly polarized light in the absorption axis orientation of the polarizer, and is absorbed by the polarizer. Therefore, it is possible to prevent extra reflection.

From the viewpoint of more effectively suppressing the extra reflection, it is preferable that the second retardation layer has substantially reverse dispersibility.

### <Support>

The laminated optical film according to the first embodiment of the present invention may further include a support. The support can be disposed at any place.

The type of the support is not particularly limited, but it is preferable that the support is transparent to visible light, and examples thereof include films made of cellulose acylate, polycarbonate, polysulfone, polyethersulfone, polyacrylate and polymethacrylate, cyclic polyolefin, polyolefin, polyamide, polystyrene, polyester, or the like. Among these, a cellulose acylate film, cyclic polyolefin, polyacrylate, or polymethacrylate is preferable. In addition, commercially available cellulose acetate films (for example, “TD80U” or “Z-TAC” manufactured by FUJIFILM Corporation) can also be used.

In addition, it is preferable that the support has a small retardation from the viewpoint of suppressing the adverse effect on the polarization degree of the transmitted light and viewpoint of facilitating the optical inspection of the laminated optical film. Specifically, a magnitude of Re is preferably 10 nm or less, and an absolute value of a magnitude of Rth is preferably 50 nm or less.

In a case where the laminated optical film according to the embodiment of the present invention is stretched or molded, it is preferable that the support has a tan δ peak temperature of 170° C. or lower. From the viewpoint that the laminated optical film can be molded at a low temperature, the tan δ peak temperature is preferably 150° C. or lower and more preferably 130° C. or lower.

Here, a method of measuring tan δ will be described. E″ (loss elastic modulus) and E′ (storage elastic modulus) of a film sample which has been humidity-adjusted in advance in an atmosphere of a temperature of 25° C. and a humidity of 60% Rh for 2 hours or longer are measured under the following conditions using a dynamic viscoelasticity measuring device (DVA-200, manufactured by IT Measurement & Control Co., Ltd.), and the values are used to acquire tan δ (=E″/E′).
Device: DVA-200, manufactured by IT Measurement & Control Co., Ltd.
Sample: 5 mm, length of 50 mm (gap of 20 mm)
Measurement conditions: tension mode
Measurement temperature: −150° C. to 220° C.
Heating conditions: 5° C./min
Frequency: 1 Hz

Typically in optical applications, a resin base material subjected to a stretching treatment is frequently used, and the tan δ peak temperature is frequently increased due to the stretching treatment. For example, with a triacetyl cellulose (TAC) base material (TG40 manufactured by FUJIFILM Corporation), the peak temperature of tan δ is 180° C. or higher.

The support having a tan δ peak temperature of 170° C. or lower is not particularly limited, and various resin base materials can be used. Examples thereof include polyolefin such as polyethylene, polypropylene, and a norbornene-based polymer; a cyclic olefin-based resin; polyvinyl alcohol; polyethylene terephthalate; an acrylic resin such as polymethacrylic acid ester and polyacrylic acid ester; polyethylene naphthalate; polycarbonate; polysulfone; polyethersulfone; polyetherketone; polyphenylene sulfide, and polyphenylene oxide. Among these, from the viewpoint of being easily available from the market and having excellent transparency, a cyclic olefin-based resin, polyethylene terephthalate, or an acrylic resin is preferable, and a cyclic olefin-based resin or polymethacrylic acid ester is particularly preferable.

Examples of commercially available resin base materials include TECHNOLLOY S001G, TECHNOLLOY S014G, TECHNOLLOY S000, TECHNOLLOY C001, and TECHNOLLOY C000 (manufactured by Sumika Acryl Co., Ltd.), LUMIRROR U type, LUMIRROR FX10, and LUMIRROR SF20 (Toray Industries, Inc.), HK-53A (Higashiyama Film Co., Ltd.), TEFLEX FT3 (Teijin DuPont Films), ESCENA″ and SCA40 (Sekisui Chemical Co., Ltd.), ZEONOR Film (ZEON CORPORATION), and an Arton Film (JSR Corporation).

A thickness of the support is not particularly limited, and is preferably 5 to 300 μm, more preferably 5 to 100 μm, and still more preferably 5 to 30 μm.

In addition, the laminated optical film according to the first embodiment may include a layer other than the above-described layers. Examples of the layer other than the above-described layers include a pressure sensitive adhesive layer formed from a pressure sensitive adhesive described later, an adhesive layer formed from an adhesive described later, and a refractive index adjusting layer.

In addition, a refractive index adjusting layer in which a difference in refractive index between a fast axis direction and a slow axis direction is smaller than that of the retardation layer may be provided between the retardation layer and the pressure sensitive adhesive or between the retardation layer and the adhesive. In addition, it is more preferable that an average refractive index of the refractive index adjusting layer is smaller than the average refractive index of the retardation layer.

### (Method of Bonding Each Layer)

The laminated optical film according to the first embodiment of the present invention is a laminate consisting of a large number of layers. Each layer can be bonded by an optional adhesion method, and for example, a pressure sensitive adhesive and an adhesive can be used. The adhesive layer and the pressure sensitive adhesive layer described later are not provided between the outermost cholesteric liquid crystal layer and the first adjacent layer.

Any commercially available pressure sensitive adhesive can be used as the pressure sensitive adhesive, but from the viewpoint of thinning and viewpoint of reducing a surface roughness Ra of the laminated optical film, a thickness thereof is preferably 25 μm or less, more preferably 15 μm or less, and still more preferably 6 μm or less. In addition, a pressure sensitive adhesive that is unlikely to generate outgas is preferable as the pressure sensitive adhesive. Particularly, in a case of performing stretching or molding, a vacuum process or a heating process may be performed, and it is preferable that no outgas is generated even under such conditions.

A commercially available adhesive or the like can be optionally used as the adhesive, and for example, an epoxy resin-based adhesive and an acrylic resin-based adhesive can be used.

From the viewpoint of thinning and viewpoint of reducing the surface roughness Ra of the laminated optical film, a thickness of the adhesive is preferably 25 μm or less, more preferably 5 μm or less, and still more preferably 1 μm or less. In addition, from the viewpoint of reducing the thickness of the adhesive layer and coating an adherend with the adhesive such that the thickness thereof is uniform, a viscosity of the adhesive is preferably 300 cP or less, more preferably 100 cP or less, and still more preferably 10 cP or less.

In addition, in a case where the adherend has surface unevenness, from the viewpoint of reducing the surface roughness Ra of the laminated optical film, an appropriate viscoelasticity or an appropriate thickness of the pressure sensitive adhesive or the adhesive can also be selected so that the surface unevenness of the layer to be bonded can be embedded. From the viewpoint of embedding the surface unevenness, it is preferable that the pressure sensitive adhesive or the adhesive has a viscosity of 50 cP or more. In addition, it is preferable that the thickness thereof is more than a height of the surface unevenness.

Examples of a method of adjusting the viscosity of the adhesive include a method of using an adhesive containing a solvent. In this case, the viscosity of the adhesive can be adjusted by a proportion of the solvent. In addition, the thickness of the adhesive can be further reduced by drying the solvent after coating the adherend with the adhesive.

In the laminated optical film, from the viewpoint of reducing the extra reflection and suppressing a decrease in polarization degrees of transmitted light and reflected light, it is preferable that the pressure sensitive adhesive or adhesive used for adhering each layer has a small difference in refractive index with adjacent layers. Specifically, the difference in refractive index with the adjacent layer is preferably 0.1 or less, more preferably 0.05 or less, and still more preferably 0.01 or less. The refractive index of the pressure sensitive adhesive or the adhesive can be adjusted, for example, by mixing fine particles of titanium oxide, fine particles of zirconia, or the like.

In addition, the retardation layer, the polarizer, and the like may have an anisotropy of refractive index in a plane, but it is preferable that the difference in refractive index with the adjacent layer is 0.05 or less in all directions in the plane. Therefore, the pressure sensitive adhesive or the adhesive may have in-plane refractive index anisotropy.

In addition, it is also preferable that the thickness of the adhesive layer between the layers is 100 nm or less. In a case where the thickness of the adhesive layer is 100 nm or less, light in the visible region is less likely to be affected by the difference in refractive index, and the reflection at the interface can be suppressed. The thickness of the adhesive layer is more preferably 50 nm or less. Examples of a method of forming the adhesive layer having a thickness of 100 nm or less include a method of vapor-depositing a ceramic adhesive such as silicon oxide (SiOx layer) on the bonding surface. For the bonding surface of the bonding member, before the bonding, a surface reforming treatment such as a plasma treatment, a corona treatment, and a saponification treatment can be performed, and a primer layer can be applied. In addition, in a case where a plurality of bonding surfaces are present, the kind and thickness of the adhesive layer can be adjusted for each of the bonding surfaces. Specifically, for example, the adhesive layer having a thickness of 100 nm or less can be provided by the procedures (1) to (3) described below.
(1) A layer to laminate is bonded to a temporary support consisting of a glass base material.
(2) An SiOx layer having a thickness of 100 nm or less is formed on both the surface of the layer to laminate and the surface of the layer to be laminated by vapor deposition or the like. The vapor deposition can be carried out by, for example, a vapor deposition device (model number ULEYES, manufactured by ULVAC, Inc.) using SiOx powder as a vapor deposition source. In addition, it is preferable that the surface of the formed SiOx layer is subjected to a plasma treatment.
(3) After the formed SiOx layers are bonded to each other, the temporary support is peeled off. It is preferable that the bonding is carried out, for example, at a temperature of 120° C.

The application, the adhesion, or the bonding of each layer may be carried out by a roll-to-roll or sheet-fed method. The roll-to-roll method is preferable from the viewpoint of improving the productivity and reducing axis misalignment of each layer.

Meanwhile, the sheet-fed method is preferable from the viewpoints that this method is suitable for production of many kinds in small quantities and that a special adhesion method in which the thickness of the adhesive layer is 100 nm or less can be selected.

In addition, examples of the method of coating the adherend with the adhesive include known methods such as a roll coating method, a gravure printing method, a spin coating method, a wire bar coating method, an extrusion coating method, a direct gravure coating method, a reverse gravure coating method, a die coating method, a spraying method, and an ink jet method.

### (Direct Application of Each Layer)

It is also preferable that the adhesive layer or the like is not provided between the layers of the laminated optical film according to the embodiment of the present invention. In a case of forming each layer, the adhesive layer can be eliminated by performing direct application onto the first adjacent layer which has already been formed. Further, in a case where one or both adjacent layers are layers containing a liquid crystal compound, it is preferable that the alignment direction of the liquid crystal compound is continuously changed at the interface in order to reduce the difference in refractive index in all in-plane directions. For example, the linear polarizer containing a liquid crystal compound and a dichroic substance is directly coated with a retardation layer containing a liquid crystal compound, and the liquid crystal compound of the retardation layer can be aligned so as to align the liquid crystal compound continuously at the interface by an orientation restriction force of the liquid crystal compound of the linear polarizer.

### (Lamination Order of Each Layer)

The laminated optical film according to the embodiment of the present invention consists of a plurality of layers, and the order of the steps of laminating the plurality of layers is not particularly limited and can be optionally selected.

For example, in a case where a functional layer is transferred from a film consisting of a temporary support and a functional layer, wrinkles or cracks during the transfer can be prevented by adjusting the laminating order such that the thickness of the film at the transfer destination reaches 10 μm or more.

In addition, from the viewpoint of reducing the surface roughness Ra of the laminated optical film, in a case where another layer is laminated on a layer having large surface unevenness, the surface unevenness may be further amplified, and thus it is preferable that the layers are laminated in order from a layer having a smaller surface roughness Ra.

In addition, from the viewpoint of improving the production yield of the laminated optical film and reducing the cost, it is also possible to select the laminating order.

### [Laminated Optical Film According to Second Embodiment]

The laminated optical film according to the second embodiment includes the above-described optical laminate according to the second embodiment and a polarizer on the reflective type linear polarizer side of the optical laminate.

Since the polarizer included in the laminated optical film according to the second embodiment is the same as the aspect of the polarizer included in the laminated optical film according to the first embodiment, the description thereof will be omitted.

It is preferable that the absorption axis of the polarizer and the reflection axis of the optical laminate according to the second embodiment are parallel to each other. By adopting the above-described aspect, a component of linearly polarized light parallel to the reflection axis of the reflective type linear polarizer in the second optical laminate can be absorbed, and thus the occurrence of ghost can be further suppressed.

In addition, the laminated optical film according to the second embodiment may include other functional layers described in the laminated optical film according to the first embodiment.

In addition, in the laminated optical film according to the second embodiment, the adhesive method of each layer, the direct coating of each layer, the lamination order of each layer, and the like in the laminated optical film according to the first embodiment can also be applied.

### [Application of Laminated Optical Film]

The laminated optical film according to the present invention (first embodiment and second embodiment) can be used as a reflective polarizer to be incorporated into, for example, an in-vehicle room mirror, a virtual reality display apparatus, an electronic finder, and the like as described in JP2017-227720A and JP2003-504663A. Particularly, in the virtual reality display device, the electronic finder, or the like, which has a reciprocating optical system allowing light to be reflected between the reflective polarizer and the half mirror to reciprocate the light, the laminated optical film according to the embodiment of the present invention is extremely useful from the viewpoint of improving clearness of a display image.

### [Optical Article]

The optical article according to the embodiment of the present invention includes the laminated optical film according to the embodiment of the present invention and a lens.

More specifically, examples of the optical article according to the first embodiment of the present invention include an aspect including the laminated optical film according to the first embodiment and a lens disposed on a side of the first adjacent layer of the laminated optical film according to the first embodiment opposite to a selective reflection layer side.

In addition, examples of the optical article according to the second embodiment of the present invention include an aspect including the laminated optical film according to the second embodiment and a lens disposed on a side of the first adjacent layer of the laminated optical film according to the second embodiment opposite to the reflective type linear polarizer side.

Examples of the lens used in the optical article (first embodiment and second embodiment) include a convex lens and a concave lens.

As the convex lens, for example, a biconvex lens, a plano-convex lens, a convex meniscus lens, or the like can be used. As the concave lens, for example, a biconcave lens, a plano-concave lens, a concave meniscus lens, or the like can be used.

As the lens used in the virtual reality display device, a convex meniscus lens and a concave meniscus lens are preferable for enlarging the angle of view, and a concave meniscus lens is more preferable in that chromatic aberration can be further suppressed.

As a material of the lens, glass, crystal, plastic, or the like, which is transparent to visible light, can be used. Since the birefringence of the lens causes rainbow unevenness or leakage light, it is preferable that the birefringence is small, and a material having substantially zero birefringence is more preferable. The laminated optical film according to the embodiment of the present invention used in the optical article according to the embodiment of the present invention may be a flat surface or a curved surface, but a curved surface is preferable from the viewpoint that distortion or aberration of an image is small.

A half mirror may be formed on one surface of the lens.

The lens and the laminated optical film (first embodiment and second embodiment) may be in contact with each other through the first adjacent layer, or may be in contact with each other through the second adjacent layer described above.

Among these, from the viewpoint of reducing the difference in refractive index at each interface, it is preferable that the lens and the laminated optical film (first embodiment and second embodiment) are in contact with each other through the second adjacent layer (for example, pressure sensitive adhesive layer).

The optical article according to the embodiment of the present invention can be preferably applied to, for example, a virtual reality display apparatus described later, and the occurrence of ghost is reduced.

### [Virtual Reality Display Device]

The optical laminate, the laminated optical film, and the optical article according to the embodiment of the present invention can be preferably applied to a virtual reality display apparatus. The virtual reality display apparatus is often used in the form of a head-mounted display. Hereinafter, a virtual reality display apparatus to which the optical laminate according to the second embodiment of the present invention is applied will be described.

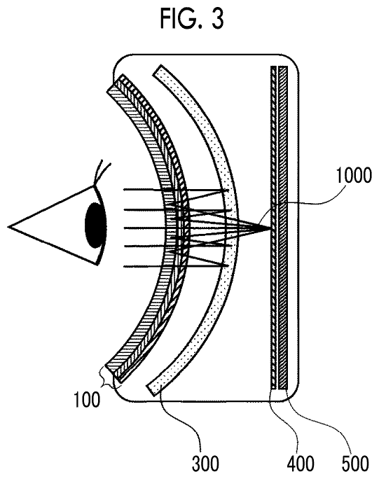

FIG. 3 is a schematic view of a virtual reality display apparatus using the laminated optical film according to the second embodiment of the present invention. In the virtual reality display apparatus of the aspect shown in FIG. 3, an optical laminate 100 including a reflective type linear polarizer, a retardation layer, and a first adjacent layer, a half mirror 300, a circular polarization plate 400, and an image display panel 500 are disposed in this order from the viewing side. As shown in FIG. 3, a ray 1000 emitted from the image display panel 500 is transmitted through the circular polarization plate 400 to be converted into circularly polarized light, and is transmitted through the half mirror 300. Next, in a case of transmitting through the retardation layer of the optical laminate 100 according to the embodiment of the present invention, the ray 1000 is converted into linearly polarized light parallel to the reflection axis of the reflective type linear polarizer, and is reflected by the reflective type linear polarizer. Next, the ray 1000 is reflected again by the half mirror 300, and is incident on the optical laminate 100 again. In this case, the polarization state of the ray 1000 is circularly polarized light having a revolution direction opposite to that of the circularly polarized light in a case of being incident on the optical laminate 100 for the first time, due to the reflection by the half mirror 300. In a case where the light in this polarization state transmits through the retardation layer of the optical laminate 100, the light is converted into linearly polarized light parallel to the transmission axis of the reflective type linear polarizer. As a result, the ray 1000 transmits through the optical laminate 100 and is visible to the user.

Here, in a case where the ray 1000 is reflected by the half mirror 300, the half mirror 300 has a concave mirror shape, and thus, the image displayed on the image display panel 500 is enlarged, and the user can view the enlarged virtual image. The above-described mechanism is called a reciprocal optical system, a folded-back optical system, or the like.

In the aspect shown in FIG. 3, in a case where light emitted to the user side of the optical laminate 100 is present in a case where light emitted from the image display panel 500 through the circular polarization plate 400 is incident on the optical laminate 100 for the first time and is reflected, the light is leakage light and may cause a ghost. Specifically, in a case where reflection occurs between the first adjacent layer and the retardation layer of the optical laminate 100, and circularly polarized light having a revolution direction opposite to that of the circularly polarized light emitted from the image display panel 500 through the circular polarization plate 400 is generated, the light is leakage light since the generated circularly polarized light transmits through the optical laminate as described above.

As described above, in a case where the optical laminate according to the second embodiment of the present invention is applied to a virtual reality display apparatus (head-mounted display), leakage light is less likely to occur due to the above-described principle, and thus the occurrence of a ghost is suppressed.

In the aspect of FIG. 3, the aspect in which the optical laminate according to the second embodiment of the present invention is used has been described. Hereinafter, even in a case where the optical laminate according to the first embodiment of the present invention is applied, the circularly polarized light is reflected by the selective reflection layer, and the circularly polarized light reflected by the half mirror is circularly polarized light having a revolution direction opposite to the revolution direction of the circularly polarized light, and thus the circularly polarized light transmits through the selective reflection layer and is emitted to the user side, and thus the optical laminate can be applied to the virtual reality display apparatus in the same manner as described above.

In addition, it is easy to understand that the laminated optical film including the optical laminate (the first embodiment and the second embodiment) and the optical article can be applied to the virtual reality display apparatus.

### Examples

Hereinafter, the present invention will be described in more detail based on Examples.

The materials, the amounts of materials used, the proportions, the treatment details, the treatment procedure, and the like shown in Examples below may be modified as appropriate as long as the modifications do not depart from the spirit of the present invention. Therefore, the scope of the present invention should not be construed as being limited to Examples shown below.

Hereinafter, Examples performed in an aspect including a cholesteric liquid crystal layer and an aspect including a reflective type linear polarizer will be described in order.

### [Preparation of Coating Liquid for Reflective Layer]

### [Coating Liquid R-1 for Reflective Layer]

A composition shown below was stirred and dissolved in a container held at 70° C. to prepare a coating liquid R-1 for a reflective layer. Here, R represents a coating liquid containing a rod-like liquid crystal compound.

Coating liquid R-1 for reflective layer

| | |
|---|---|
| Methyl ethyl ketone: | 120.9 parts by mass |
| Cyclohexanone: | 21.3 parts by mass |
| Mixture X of rod-like liquid crystal compounds shown below: | 100.0 parts by mass |
| Photopolymerization initiator B shown below: | 1.00 part by mass |
| Chiral agent A shown below: | 4.18 parts by mass |
| Surfactant F1 shown below: | 0.1 parts by mass |

Mixture X of rod-like liquid crystal compounds

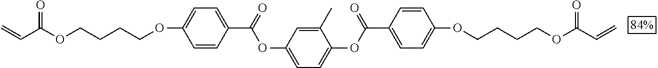 [SMILES: C=CC(=O)OCCCCOc1ccc(C(=O)Oc2ccc(OC(=O)c3ccc(OCCCCOC(=O)C=C)cc3)c(C)c2)cc1]

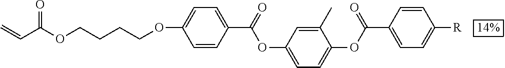

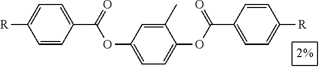

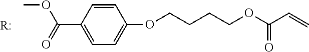

In the above-described mixture X, each numerical value denotes the content in units of % by mass. In addition, R is a group bonded through an oxygen atom. Furthermore, an average molar absorption coefficient of the above-described rod-like liquid crystal compound at a wavelength of 300 to 400 nm was 140/mol·cm.

### Chiral Agent A

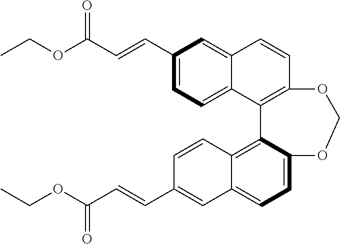

### Surfactant F1

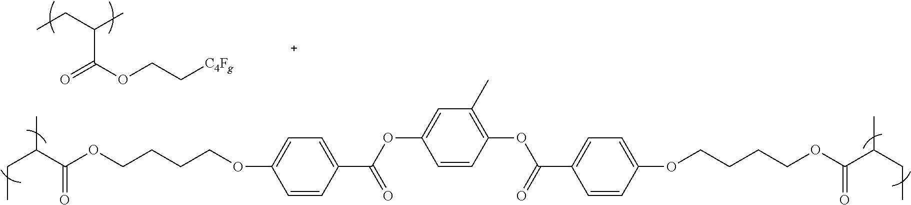

### Photopolymerization Initiator B

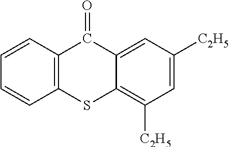 [SMILES: CCc1cc(CC)c2sc3ccccc3c(=O)c2c1]

The chiral agent A was a chiral agent in which helical twisting power (HTP) was reduced by light.

### [Coating Liquid R-2 for Reflective Layer]

A coating liquid was prepared in the same manner as in the coating liquid R-1 for a reflective layer, except that the amount of the chiral agent A added was changed as shown in Table 1.

TABLE 1

| Coating | Chiral agent |
|---|---|
| liquid | amount |
| name | (part by mass) |
| Liquid R-1 | 4.18 |
| Liquid R-2 | 3.00 |

### [Coating Liquid D-1 for Reflective Layer]

A composition shown below was stirred and dissolved in a container held at 50° C. to prepare a coating liquid D-1 for a reflective layer. Here, D represents a coating liquid containing a disk-like liquid crystal compound.

Coating liquid D-1 for reflective layer

| | |
|---|---|
| Disk-like liquid crystal compound (A) shown below: | 80 parts by mass |
| Disk-like liquid crystal compound (B) shown below: | 20 parts by mass |
| Polymerizable monomer E1 shown below: | 10 parts by mass |
| Surfactant F2 shown below: | 0.3 parts by mass |
| Photopolymerization initiator (IRGACURE 907 manufactured by BASF SE): | 3 parts by mass |
| Chiral agent A shown above: | 5.45 parts by mass |
| Methyl ethyl ketone: | 290 parts by mass |
| Cyclohexanone: | 50 parts by mass |

Disk-like liquid crystal compound (A) 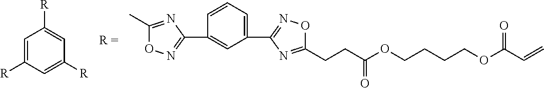
Disk-like liquid crystal compound (B) 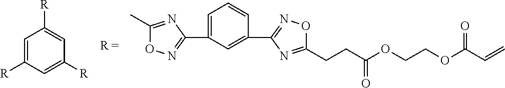
Polymerizable monomer E1 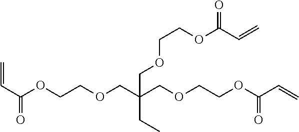 [SMILES: C=CC(=O)OCCOCC(CC)(COCCOC(=O)C=C)COCCOC(=O)C=C]
Surfactant F2 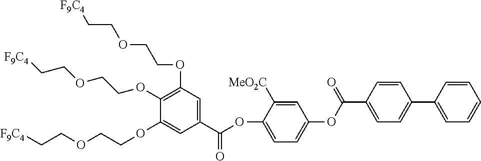
[Coating liquids D-2 and D-3 for reflective layer]

Coating liquids D-2 and D-3 for a reflective layer were prepared in the same manner as in the coating liquid D-1 for a reflective layer, except that the amount of the chiral agent A added was changed as shown in Table 2.

TABLE 2

| Coating | Chiral agent amount |
|---|---|
| liquid name | (part by mass) |
| Liquid D-1 | 5.45 |
| Liquid D-2 | 4.52 |
| Liquid D-3 | 4.10 |

### [Production of Reflective Circular Polarizer 1]

A PET film (manufactured by TOYOBO Co., Ltd., A4265) having a thickness of 100 μm was prepared as a temporary support, and a PET surface on a side where an easy adhesive layer was not formed subjected to the rubbing treatment.

The coating liquid R-1 for a reflective layer prepared as described above was applied using a wire bar coater, and dried at 110° C. for 72 seconds. Thereafter, the surface was irradiated with light using a metal halide lamp at 100° C., an illuminance of 80 mW/cm², and an irradiation amount of 500 mJ/cm² in a low oxygen atmosphere (100 ppm or less), thereby curing the coating liquid to form a first blue light reflective layer consisting of a cholesteric liquid crystal layer (first cholesteric liquid crystal layer). The irradiation with light was carried out from the side of the cholesteric liquid crystal layer. Here, the coating thickness was adjusted so that the film thickness of the cured first blue light reflective layer was 2.6 μm.

Next, the surface of the first blue light reflective layer was subjected to a corona treatment at a discharge amount of 150 W·min/m², and the surface subjected to the corona treatment was coated with the coating liquid D-1 for a reflective layer using a wire bar coater.

Subsequently, the coating film was dried at 70° C. for 2 minutes and heat-aged at 115° C. for 3 minutes after the solvent was vaporized, thereby obtaining a uniform alignment state. Thereafter, the coating film was kept at 45° C. and irradiated with ultraviolet rays (300 mJ/cm²) using a metal halide lamp in a nitrogen atmosphere, thereby curing the coating film to form a second blue light reflective layer (second cholesteric liquid crystal layer) on the first blue light reflective layer. The irradiation with light was carried out from the side of the cholesteric liquid crystal layer. In this case, the coating thickness was adjusted such that the film thickness of the second blue light reflective layer after curing was 2.0 μm.

Next, the second blue light reflective layer was coated with the coating liquid D-2 for a reflective layer using a wire bar coater. Subsequently, the coating film was dried at 70° C. for 2 minutes and heat-aged at 115° C. for 3 minutes after the solvent was vaporized, thereby obtaining a uniform alignment state.

Thereafter, the coating film was kept at 45° C. and irradiated with ultraviolet rays (300 mJ/cm²) using a metal halide lamp in a nitrogen atmosphere, thereby curing the coating film to form a green light reflective layer (third cholesteric liquid crystal layer) on the second blue light reflective layer. The irradiation with light was carried out from the side of the cholesteric liquid crystal layer. In this case, the coating thickness was adjusted such that the film thickness of the green light reflective layer after curing was 2.7 μm.

Next, the green light reflective layer was coated with the coating liquid R-2 for a reflective layer using a wire bar coater and dried at 110° C. for 72 seconds.

Thereafter, the surface was irradiated with light using a metal halide lamp at 100° C., an illuminance of 80 mW/cm², and an irradiation amount of 500 mJ/cm² in a low oxygen atmosphere (100 ppm or less), thereby curing the coating liquid to form a red light reflective layer (fourth cholesteric liquid crystal layer) on the green light reflective layer. The irradiation with light was carried out from the side of the cholesteric liquid crystal layer. In this case, the coating thickness was adjusted such that the film thickness of the red light reflective layer after curing was 3.4 μm.

Next, the surface of the red light reflective layer was subjected to a corona treatment at a discharge amount of 150 W·min/m², and the surface subjected to the corona treatment was coated with the coating liquid D-3 for a reflective layer using a wire bar coater. S Subsequently, the coating film was dried at 70° C. for 2 minutes and heat-aged at 115° C. for 3 minutes after the solvent was vaporized, thereby obtaining a uniform alignment state.

Thereafter, the coating film was kept at 45° C. and irradiated with ultraviolet rays (300 mJ/cm²) using a metal halide lamp in a nitrogen atmosphere, thereby curing the coating film to form a yellow light reflective layer (fifth cholesteric liquid crystal layer) on the red light reflective layer. The irradiation with light was carried out from the side of the cholesteric liquid crystal layer. In this case, the coating thickness was adjusted such that the film thickness of the yellow light reflective layer after curing was 3.4 μm.

A reflective circular polarizer 1 (selective reflection layer) including the first cholesteric liquid crystal layer to the fifth cholesteric liquid crystal layer in this order was obtained by the above-described procedure.

For each cholesteric liquid crystal layer of the produced reflective circular polarizer 1, a reflection center wavelength and a film thickness are shown in Table 3. Here, the reflection center wavelength shown in Table 3 corresponds to a central wavelength of the reflected light of the above-described cholesteric liquid crystal layer. The reflection center wavelength (central wavelength of the reflected light) was confirmed by producing a film of each cholesteric liquid crystal layer, obtained by applying only a single layer. The film thickness was obtained by SEM.

TABLE 3

| | | Reflective | |
|---|---|---|---|
| | | central | Film |
| | Type of | wavelength | thickness |
| | coating liquid | (nm) | (μm) |
| 5th layer | Liquid D-3 | 586 | 3.4 |
| 4th layer | Liquid R-2 | 661 | 3.4 |
| 3rd layer | Liquid D-2 | 531 | 2.7 |
| 2nd layer | Liquid D-1 | 441 | 2.0 |
| 1st layer | Liquid R-1 | 475 | 2.6 |

### [Preparation of Reflective Circular Polarizer 2]

### [Coating Liquid R-3 for Reflective Layer]

A composition shown below was stirred and dissolved in a container held at 70° C. to prepare a coating liquid R-3 for a reflective layer. Here, R represents a coating liquid containing a rod-like liquid crystal compound.

Coating liquid R-3 for reflective layer

| | |
|---|---|
| Methyl ethyl ketone: | 120.9 parts by mass |
| Cyclohexanone: | 21.3 parts by mass |
| Rod-like liquid crystal compound X2 shown below: | 100.0 parts by mass |
| Photopolymerization initiator B shown above: | 1.00 part by mass |
| Chiral agent A shown above: | 4.18 parts by mass |
| Surfactant F1 shown above: | 0.1 parts by mass |

Rod-Like Liquid Crystal Compound X2 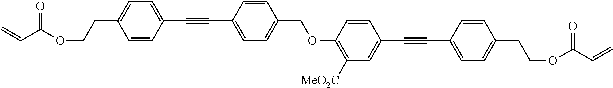 [SMILES: C=CC(=O)OCCc1ccc(C#Cc2ccc(COc3ccc(C#Cc4ccc(CCOC(=O)C=C)cc4)cc3C(=O)OC)cc2)cc1]
[Coating liquid R-4 for reflective layer]

A coating liquid was prepared in the same manner as in the coating liquid R-3 for a reflective layer, except that the amount of the chiral agent A added was changed as shown in Table 4.

TABLE 4

| Coating | Chiral agent |
|---|---|
| liquid | amount |
| name | (part by mass) |
| Liquid R-3 | 4.35 |
| Liquid R-4 | 2.86 |

### [Coating Liquid D-4 for Reflective Layer]

The following composition was stirred and dissolved to prepare a coating liquid D-4 for a reflective layer. Here, D represents a coating liquid containing a disk-like liquid crystal compound.

Coating liquid D-4 for reflective layer

| | |
|---|---|
| Disk-like liquid crystal compound (C) shown below: | 100 parts by mass |
| Polymerizable monomer shown above E1: | 10 parts by mass |
| Surfactant F2 shown above: | 0.3 parts by mass |
| Photopolymerization initiator (IRGACURE 907 manufactured by BASF SE): | 3 parts by mass |
| Chiral agent A shown above: | 5.45 parts by mass |
| Methylene chloride: | 340 parts by mass |

Disk-Like Liquid Crystal Compound (C) 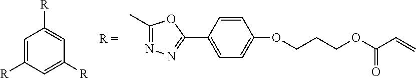
[Coating liquids D-5 and D-6 for reflective layer]

Coating liquids D-5 and D-6 for a reflective layer were prepared in the same manner as in the coating liquid D-4 for a reflective layer, except that the amount of the chiral agent A added was changed as shown in Table 5.

TABLE 5

| Coating | Chiral agent amount |
|---|---|
| liquid name | (part by mass) |
| Liquid D-4 | 5.83 |
| Liquid D-5 | 4.65 |
| Liquid D-6 | 4.04 |

A reflective circular polarizer 2 was produced by performing coating in the same manner as in the reflective circular polarizer 1, except that the coating liquids were used and the film thickness after curing was adjusted to the value shown in Table 6.

TABLE 6

| | | Reflective | |
|---|---|---|---|
| | | central | Film |
| | Type of | wavelength | thickness |
| | coating liquid | (nm) | (μm) |
| 5th layer | Liquid D-6 | 606 | 2.4 |
| 4th layer | Liquid R-4 | 706 | 1.9 |
| 3rd layer | Liquid D-5 | 526 | 2.3 |
| 2nd layer | Liquid D-4 | 420 | 1.4 |
| 1st layer | Liquid R-3 | 464 | 1.4 |

### [Production of Laminated Optical Film]

A laminated optical film was produced by the following procedure.

### [Manufacturing of Retardation Layer 1]

A retardation layer 1 having reverse wavelength dispersibility was produced with reference to the method described in paragraphs 0151 to 0163 of JP2020-084070A.

Re of the retardation layer 1 was 146 nm and Rth thereof was 73 nm.

### [Production of Positive C-Plate 2]

A positive C-plate 2 was produced by adjusting the film thickness with reference to the method described in paragraphs 0132 to 0134 of JP2016-053709A. Here, the support was changed from a polyethylene terephthalate film (PET film) to a triacetyl cellulose film (TAC film).

In the positive C-plate 2, Re was 0.1 nm and Rth was-80 nm.

### [Production of Linear Polarizer]

A linear polarizer was produced through the following procedure.

### (Production of Cellulose Acylate Film 1)

### <Production of Core Layer Cellulose Acylate Dope>

The following composition was put into a mixing tank and stirred to dissolve each component, thereby preparing a cellulose acetate solution used as a core layer cellulose acylate dope.

Core layer cellulose acylate dope

| | |
|---|---|
| Cellulose acetate having acetyl substitution degree of 2.88: | 100 parts by mass |
| Polyester compound B described in Examples of JP2015-227955A: | 12 parts by mass |
| Compound F shown below: | 2 parts by mass |
| Methylene chloride (first solvent): | 430 parts by mass |
| Methanol (second solvent): | 64 parts by mass |

Compound F 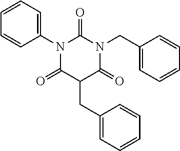 [SMILES: O=C1C(Cc2ccccc2)C(=O)N(c2ccccc2)C(=O)N1Cc1ccccc1]
<Preparation of outer layer cellulose acylate dope>

10 parts by mass of the following matting agent solution was added to 90 parts by mass of the core layer cellulose acylate dope to prepare a cellulose acetate solution to be used as an outer layer cellulose acylate dope.

Matting agent solution
Silica particles with average particle size of 20 nm
(AEROSIL R972, manufactured by Nippon Aerosil Co., Ltd.): 2 parts by mass
Methylene chloride (first solvent): 76 parts by mass
Methanol (second solvent): 11 parts by mass
Core layer cellulose acylate dope described above: 1 part by mass

### <Production of Cellulose Acylate Film 1>

The core layer cellulose acylate dope and the outer layer cellulose acylate dope were filtered through filter paper having an average hole diameter of 34 μm and a sintered metal filter having an average pore size of 10 μm, and three layers which were the core layer cellulose acylate dope and the outer layer cellulose acylate dopes provided on both sides of the core layer cellulose acylate dope were simultaneously cast from a casting port onto a drum at 20° C. (band casting machine).

Next, the film was peeled off in a state where the solvent content was approximately 20% by mass, both ends of the film in the width direction were immobilized by tenter clips, and the film was dried while being stretched at a stretching ratio of 1.1 times in the lateral direction.

Thereafter, the film was further dried by being transported between the rolls of the heat treatment device to prepare an optical film having a thickness of 40 μm, and the optical film was used as a cellulose acylate film 1. Re of the obtained cellulose acylate film 1 was 0 nm.

(Formation of photo-alignment layer PA1)

The cellulose acylate film 1 was continuously coated with a coating liquid S-PA-1 for forming an alignment layer described below with a wire bar. The support on which the coating film was formed was dried with hot air at 140° C. for 120 seconds, and the coating film was irradiated with polarized ultraviolet rays (10 mJ/cm², using an ultra-high pressure mercury lamp) to form a photo-alignment layer PA1. A film thickness thereof was 0.3 μm.

(Coating liquid S-PA-1 for forming alignment layer)

| | |
|---|---|
| Polymer M-PA-1 shown below: | 100.00 parts by mass |
| Acid generator PAG-1 shown below: | 5.00 parts by mass |
| Acid generator CPI-110TF shown below: | 0.005 parts by mass |
| Xylene: | 1220.00 parts by mass |
| Methyl isobutyl ketone: | 122.00 parts by mass |

Polymer M-PA-1 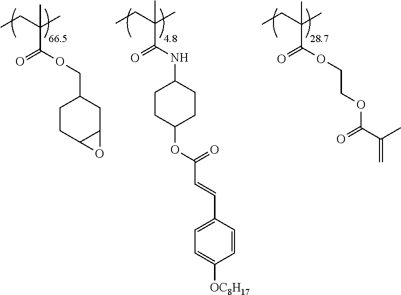
Acid generator PAG-1 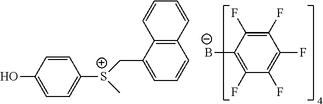
Acid generator CPI-110TF 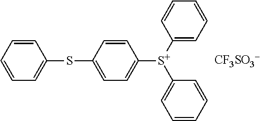
(Formation of light absorption anisotropic layer P1)

The obtained photo-alignment layer PA1 was continuously coated with the following coating liquid S—P-1 for forming a light-absorbing anisotropic layer using a wire bar to form a coating layer.

Next, the formed coating layer was heated at 140° C. for 30 seconds, and the coating layer was cooled to room temperature (23° C.). Next, the coating layer P¹ was heated at 90° C. for 60 seconds and cooled to room temperature again.

Thereafter, the coating layer P1 was irradiated with an LED lamp (central wavelength of 365 nm) for 2 seconds under an irradiation condition of illuminance of 200 mW/cm², thereby forming a light absorption anisotropic layer P1 on the alignment layer PA1. A film thickness thereof was 1.6 μm.

Composition of coating liquid S-P-1 for forming light-absorbing anisotropic layer

| | |
|---|---|
| Dichroic substance D-1 shown below: | 0.25 parts by mass |
| Dichroic substance D-2 shown below: | 0.36 parts by mass |
| Dichroic substance D-3 shown below: | 0.59 parts by mass |
| Polymer liquid crystal compound M-P-1 shown below: | 2.21 parts by mass |
| Low-molecular-weight liquid crystal compound M-1: | 1.36 parts by mass |
| Polymerization initiator IRGACURE OXE-02 (manufactured by BASF SE): | 0.200 parts by mass |
| Surfactant F-3 shown below: | 0.026 parts by mass |
| Cyclopentanone: | 46.00 parts by mass |
| Tetrahydrofuran: | 46.00 parts by mass |
| Benzyl alcohol: | 3.00 parts by mass |

Dichroic substance D-1 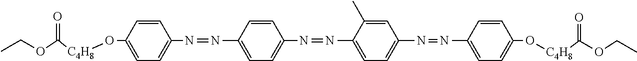
Dichroic substance D-2 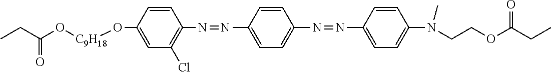
Dichroic substance D-3 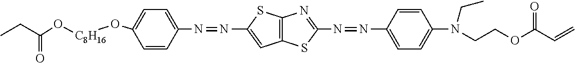
Polymer liquid crystal compound M-P-1 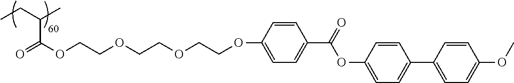 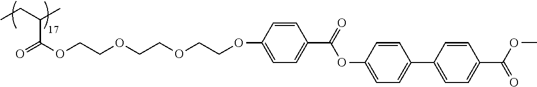 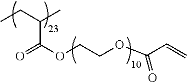
Low-Molecular-Weight Liquid Crystal Compound M-1 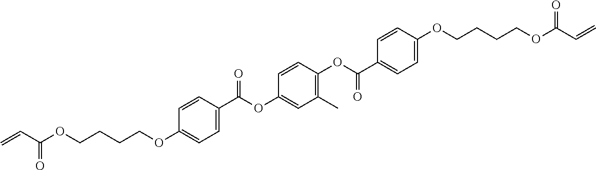 [SMILES: C=CC(=O)OCCCCOc1ccc(C(=O)Oc2ccc(OC(=O)c3ccc(OCCCCOC(=O)C=C)cc3)c(C)c2)cc1]
Surfactant F-3 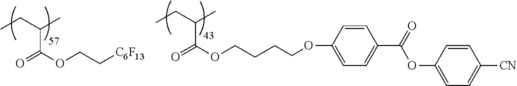
[Production of laminated film]

The above-described members were bonded to each other according to the following procedure to obtain a laminated film 1 and a laminated film 2.

A UV adhesive Chemi-seal U2084B (manufactured by ChemiTech Inc., refractive index n after curing n: 1.60) was applied onto the PMMA base material using a wire bar coater such that the thickness was set to 2 μm. The light absorption anisotropic layer P1 was bonded to the formed adhesive layer. The light absorption anisotropic layer P1 was bonded using a laminator such that the surface of the light absorption anisotropic layer P1 on the side opposite to the temporary support was in contact with the adhesive layer.

Next, the inside of the purge box was purged with nitrogen until the oxygen concentration reached 100 ppm or less, and then the adhesive layer was cured by irradiating the light absorption anisotropic layer P1 from the temporary support side with ultraviolet rays of a high-pressure mercury lamp. The illuminance was 25 mW/cm² and the irradiation amount was 1,000 mJ/cm².

Finally, the temporary support of the light absorption anisotropic layer P1 was peeled off.

A UV adhesive layer was formed on the exposed surface of the light absorption anisotropic layer P1 according to the same procedure as described above, and the retardation layer 1 was bonded thereto. Here, the retardation layer 1 and the light absorption anisotropic layer P1 were laminated such that the angle formed by the slow axis of the retardation layer 1 and the absorption axis of the light absorption anisotropic layer P1 was 45°. Next, a UV adhesive layer was formed on the retardation layer 1 according to the same transfer procedure as described above, and the positive C-plate 2 was bonded thereto.

Finally, a UV adhesive layer was formed on the positive C-plate 2 according to the same procedure as described above, and the reflective circular polarizer 1 was bonded thereto to produce a laminated film 1. The surface of the reflective circular polarizer 1 on the fifth cholesteric liquid crystal layer side and the UV adhesive layer were bonded to be in contact with each other. In addition, the PET film of the reflective circular polarizer 1 of the laminated film 1 was peeled off to expose the surface of the first cholesteric liquid crystal layer.

The laminated film 1 had the reflective circular polarizer 1 (selective reflection layer), the positive C-plate 2, the retardation layer 1, and the light absorption anisotropic layer P1 in this order.

A laminated film 2 having the reflective circular polarizer 2 was produced according to the same procedure as in the production of the laminated film 1, except that the reflective circular polarizer 2 was used instead of the reflective circular polarizer 1.

### [Formation of First Adjacent Layer 1]

A hard coat layer (first adjacent layer 1) having a refractive index of 1.52 and a film thickness of 2 μm was formed on the surface of the laminated film 1 on the reflective circular polarizer 1 side. The composition and the forming method of the hard coat layer coating liquid are shown below.

(Coating liquid HC-1 for hard coat layer)
Polymerizable compound 1: 22 parts by mass
(10-functional urethane acrylate (UV-1700B manufactured by Nippon Gohsei
Chemical Co., Ltd.))
Photopolymerization initiator: 0.5 parts by mass
(Oxime ester-based (IRGACURE OXE01, manufactured by BASF Japan Ltd.
Methyl ethyl ketone: 800.00 parts by mass

The surface of the above-described laminated film 1 on the reflective circular polarizer 1 side (surface of the first cholesteric liquid crystal layer) was coated with the above-described coating liquid HC-1 for a hard coat layer using a wire bar coater, and dried at 80° C. for 60 seconds.

Thereafter, the surface was irradiated with light of an ultraviolet LED lamp (wavelength: 365 nm) at 78° C. and an irradiation amount of 300 mJ/cm² in a low oxygen atmosphere (100 ppm).

A hard coat layer (first adjacent layer 1) was formed by the above-described procedure. The first adjacent layer 1 had a refractive index of 1.52 and a film thickness of 2 μm. The hard coat layer was composed of a cured product of the above-described polymerizable compound 1.

A laminated optical film 1 was obtained by the above-described procedure.

A portion of the reflective circular polarizer 1 (first cholesteric liquid crystal layer to fifth cholesteric liquid crystal layer) and the adjacent layer 1 in the laminated optical film 1 corresponded to the optical laminate 1. In addition, the first cholesteric liquid crystal layer corresponded to the outermost cholesteric liquid crystal layer.

### [Production of Laminated Optical Films 2 to 4]

Adjacent layers 2 to 4 were formed on the surface of the above-described laminated film 1 on the reflective circular polarizer 1 side (surface of the first cholesteric liquid crystal layer) by the following method, and laminated optical films 2 to 4 were produced.

(Formation of First Adjacent Layer in which Refractive Index Changes in Thickness Direction)

The formulation of the coating liquid HC-2 for a hard coat layer is shown below.

(Coating liquid HC-2 for hard coat layer)
Polymerizable compound 1: 20 parts by mass
(10-functional urethane acrylate (UV-1700B manufactured by Nippon Gohsei
Chemical Co., Ltd.)
Polymerizable compound 2: 2 parts by mass
(Fluorene compound (Ogsol EA0200, manufactured by Osaka Gas Chemicals Co.,
Ltd.))
Photopolymerization initiator: 0.5 parts by mass
(Oxime ester-based (IRGACURE OXE01, manufactured by BASF Japan Ltd.))
Methyl ethyl ketone: 800.00 parts by mass

The hard coat layer is obtained by applying the coating liquid HC-2 for a hard coat layer and curing the coating liquid HC-2 for a hard coat layer by the method described in the first adjacent layer 1, and the refractive index is 1.53.

Here, as shown in Table 7 below, the hard coat layer having a refractive index of 1.52 to 1.63 is obtained by adjusting the content ratio of the polymerizable compound 1 and the polymerizable compound 2 contained in the coating liquid HC-2 for a hard coat layer. In a case where a coating liquid in which the content ratio of the polymerizable compound 1 and the polymerizable compound 2 in the coating liquid HC-2 for a hard coat layer is adjusted is sequentially applied to form a hard coat layer, the first adjacent layer in which the refractive index changes in the thickness direction can be formed.

By the above-described procedure, the first adjacent layer (first adjacent layers 2 to 4) in which the refractive index n1 on the outermost cholesteric liquid crystal layer side of the first adjacent layer and the refractive index n2 on the side of the first adjacent layer opposite to the outermost cholesteric liquid crystal layer are different from each other and the refractive index changes in the thickness direction is formed. Specifically, for example, the first adjacent layer 2 is formed by sequentially applying and curing the coating liquids HC-1 to HC6 for a hard coat layer described in Table 7, and the first adjacent layer 2 in which n1 is 1.57 and n2 is 1.52 is formed. The first adjacent layers 3 and 4 are also formed by the same method.

The film thickness of the first adjacent layer is adjusted to 2 μm by adjusting the film thickness condition of each layer.

The laminated optical films 2 to 4 are obtained by the above-described procedure.

Table 8 shows the refractive index n1 on the outermost cholesteric liquid crystal layer side and the refractive index n2 on the side opposite to the outermost cholesteric liquid crystal layer side of each of the formed first adjacent layers.

### [Production of Laminated Optical Film 5]

A laminated optical film 5 including a first adjacent layer 5 having the refractive index characteristics shown in Table 8 was obtained on the surface of the above-described laminated film 2 on the reflective circular polarizer 2 side by the same method as the method shown in the laminated optical films 2 to 4.

TABLE 7

| | Polymerizable | Polymerizable | |
|---|---|---|---|
| Type of coating | compound 1 | compound 2 | Refractive |
| layer | (part by mass) | (part by mass) | index |
| Liquid HC-1 | 22.0 | 0.0 | 1.52 |
| Liquid HC-2 | 20.0 | 2.0 | 1.53 |
| Liquid HC-3 | 18.0 | 4.0 | 1.54 |
| Liquid HC-4 | 16.0 | 6.0 | 1.55 |
| Liquid HC-5 | 14.0 | 8.0 | 1.56 |
| Liquid HC-6 | 12.0 | 10.0 | 1.57 |
| Liquid HC-7 | 10.0 | 12.0 | 1.58 |
| Liquid HC-8 | 8.0 | 14.0 | 1.59 |
| Liquid HC-9 | 6.0 | 16.0 | 1.60 |
| Liquid HC-10 | 4.0 | 18.0 | 1.61 |
| Liquid HC-11 | 2.0 | 20.0 | 1.62 |
| Liquid HC-12 | 0.0 | 22.0 | 1.63 |

TABLE 8

| Adjacent layer | n1 | n2 |
|---|---|---|
| Adjacent layer 1 | 1.52 | 1.52 |
| Adjacent layer 2 | 1.57 | 1.52 |
| Adjacent layer 3 | 1.60 | 1.52 |
| Adjacent layer 4 | 1.63 | 1.52 |
| Adjacent layer 5 | 1.63 | 1.52 |

### [Production of Optical Article]

### [Formation of Half Mirror on Lens]

A convex surface side of a lens (convex meniscus lens LE1076-A (diameter: 2 inches, focal length: 100 mm) manufactured by Thorlabs, Inc.) was subjected to aluminum vapor deposition so that the reflectance was 40%, thereby forming a half mirror. A lens with a half mirror 1 was obtained according to the above-described procedure.

### [Method of Forming Laminated Optical Film]

Each of the produced laminated optical films was formed into a curved shape. Hereinafter, the forming procedure of the laminated optical film 1 will be described, but each of the laminated optical films was also formed in the same manner.

The laminated optical film 1 was set in a molding device. A forming space in the forming device consisted of a box 1 and a box 2 partitioned by the laminated optical film 1, and the half mirror-attached lens 1 was disposed as a mold in the box 1 on the lower side of the laminated optical film 1 such that the concave surface was on the upper side. In this case, the first adjacent layer 1 side of the laminated optical film 1 was disposed on the mold side.

In addition, a transparent window was installed on the upper part of the box 2 on the upper side of the laminated optical film 1, and an IR light source for heating the laminated optical film 1 was installed on the outside of the box 2.

A patterned infrared reflecting filter consisting of a cholesteric liquid crystal layer that reflects infrared ray having a wavelength of 2.2 μm to 3.0 μm with a reflectance of about 50% was disposed between the IR light source and the laminated optical film 1. The pattern of the patterned infrared reflecting filter is donut-shaped, and is obtained by hollowing out a central portion of a circular infrared reflection filter having a diameter of 2 inches with a diameter of 1 inch. In this case, the center portion of the patterned infrared reflective filter was disposed to coincide with the center portion of the mold in a case of being viewed from directly above.

In the above-described disposition, the inside of the box 1 and the inside of the box 2 were evacuated with a vacuum pump to be 0.1 atm or less.

Next, as a step of heating the laminated optical film 1, the laminated optical film 1 was irradiated with infrared rays from the IR light source, and heated until the center portion of the laminated optical film 1 reached 108° C. and the end portion reached 99° C. Since the glass transition temperature Tg of the PMMA film used as the support was 105° C., the center portion was easily stretched and the end portion was difficult to stretch during the forming.

In a state where the laminated optical film 1 was heated, the laminated optical film 1 was pressed against the mold and deformed along the shape of the mold. Specifically, gas was allowed to flow into the box 2 from a gas cylinder to pressurize the box 2 to 300 kPa, and the laminated optical film 1 was pressure-bonded to the mold.

Finally, the laminated optical film 1 was removed from the lens which is a mold. In this manner, a laminated optical film 1 molded into a curved surface was obtained.

In a case where the laminated optical film 1 formed into a curved surface and the lens were combined, the optical article according to the embodiment of the present invention was obtained.

### Evaluation

### [Production of Virtual Reality Display Apparatus]

A virtual reality display device “Huawei VR Glass” manufactured by Huawei Technologies Co., Ltd., which was a virtual reality display device for which a reciprocating optical system was employed, was disassembled, and all composite lenses were taken out.

The composite lens 1 (optical article 1) in which the laminated optical film 1 formed as described above was bonded to the half mirror-attached lens 1 was incorporated into the main body instead of the taken-out composite lens, thereby producing a virtual reality display apparatus of Comparative Example 1.

The laminated optical film 1 and the half mirror-attached lens 1 were bonded to each other using a UV adhesive (UVX6282, refractive index at time of curing: 1.50) manufactured by Toagosei Co., Ltd., such that the first adjacent layer 1 faced the half mirror-attached lens 1. The adhesive layer formed of the above-described UV adhesive corresponds to the second adjacent layer.

In addition, the laminated optical films 2 to 5 were also bonded to the half mirror-attached lens 1 and incorporated into the main body of the virtual reality display apparatus by the same procedure as described above, thereby producing virtual reality display apparatuses of Comparative Example 2 and Examples 1 to 3.

The refractive index of the adhesive layer was measured with an interference film thickness meter OPTM (manufactured by Otsuka Electronics Co., Ltd., analyzed by least squares method).

In addition, the refractive index of the outermost cholesteric liquid crystal layer was measured by the following method.

First, the cholesteric liquid crystal layer (outermost cholesteric liquid crystal layer) adjacent to the adhesive layer was peeled off and acquired, and a cross section thereof was observed with an SEM to acquire the number of helical pitches P. The number of helical pitches P is two periods of the stripe pattern of bright and dark streaks appearing in the SEM image.

Next, the reflection spectrum of the outermost cholesteric liquid crystal layer was measured with a spectrophotometer (manufactured by JASCO Corporation, ultraviolet-visible-near infrared spectrophotometer V-750), and the short-wavelength-side half-value wavelength λmin and the long-wavelength-side half-value wavelength λmax of the reflection band of the outermost cholesteric liquid crystal layer were acquired. Using the number of helical pitches P and the half-value wavelengths λmin and λmax, nmin and nmax were obtained from Expression (1) and Expression (2).

### [Evaluation of Ghost]

In the produced virtual reality display apparatus, a black-and-white checkerboard pattern was displayed on the image display panel, and the visibility of the ghost was visually evaluated according to the following standard. In practice, the evaluation of A to C is preferable, and the evaluation of A or B is more preferable.
A; ghost is not visible at all.
B; ghost is slightly visible, but not noticeable.
C; weak ghost is visible.
D; slightly strong ghost is visible.
E; strong ghost is visible.

The evaluation results of the visibility of the ghost are shown in Table 9.

In Table 9, the columns of Expression (3) to Expression (6) are denoted as “A” in a case where each expression is satisfied, and are denoted as “B” in a case where each expression is not satisfied.

TABLE 9

| | | Comparative | Comparative | | | |
|---|---|---|---|---|---|---|
| | | Example 1 | Example 2 | Example 1 | Example 2 | Example 3 |
| Laminated | Type | Laminated | Laminated | Laminated | Laminated | Laminated |
| optical film | | optical film 1 | optical film 2 | optical film | optical film | optical film |
| | | | | 3 | 4 | 5 |
| Reflective | Type | Reflective | Reflective | Reflective | Reflective | Reflective |
| circular | | circular | circular | circular | circular | circular |
| polarizer | | polarizer 1 | polarizer 1 | polarizer 1 | polarizer 1 | polarizer 2 |
| | nmax | 1.71 | 1.71 | 1.71 | 1.71 | 1.77 |
| | nmin | 1.55 | 1.55 | 1.55 | 1.55 | 1.55 |
| First | Type | Adjacent | Adjacent | Adjacent | Adjacent | Adjacent |
| adjacent | | layer 1 | layer 2 | layer 3 | layer 4 | layer 5 |
| layer | n1 | 1.52 | 1.57 | 1.6 | 1.63 | 1.63 |
| | n2 | 1.52 | 1.52 | 1.52 | 1.52 | 1.52 |
| | Expression | A | A | A | A | A |
| | (3) | | | | | |
| | Expression | B | A | A | A | A |
| | (4) | | | | | |
| | Expression | B | B | A | A | A |
| | (5) | | | | | |
| Second | n3 | 1.50 | 1.50 | 1.50 | 1.50 | 1.50 |
| adjacent | Expression | A | A | A | A | A |
| layer | (6) | | | | | |

| | | | | | |
|---|---|---|---|---|---|
| Ghost visibility | D | D | C | B | C |

From the results shown in Table 9, in the virtual reality display apparatuses of Examples 1 to 3, the ghost was at a level that was not noticeable over the entire region of the lens, or the ghost was weak, and the occurrence of the ghost was suppressed. On the other hand, in the virtual reality display apparatuses of Comparative Examples 1 and 2, a part of the light in the white display region was visible as a slightly strong ghost in the black display region of the checkerboard pattern, and the occurrence of the ghost could not be suppressed.

That is, it was confirmed that, in a case where the optical laminate satisfying the requirements of Expressions (1) to (5) was applied to the virtual reality display apparatus (head-mounted display), the occurrence of the ghost was suppressed.

Hereinafter, an aspect including the reflective type linear polarizer will be described.

### [Preparation of Coating Liquid A-1 for Retardation Layer]

A composition shown below was stirred and dissolved in a container kept at 70° C. to prepare a coating liquid A-1 for a retardation layer having reverse wavelength dispersibility.

Coating liquid A-1 for retardation layer

| | |
|---|---|
| Polymerizable liquid crystal compound X-1 shown below: | 16.00 parts by mass |
| Specific liquid crystal compound L-1 shown below: | 42.00 parts by mass |
| Specific liquid crystal compound L-2 shown below: | 42.00 parts by mass |
| Polymerization Initiator S-1 shown below: | 0.50 parts by mass |
| Acid anhydride K-1 shown below: | 4.00 parts by mass |
| Polymerizable compound B-1 shown below: | 2.00 parts by mass |
| Leveling agent (the following compound T-1): | 0.20 parts by mass |
| Methyl ethyl ketone (solvent): | 230.00 parts by mass |
| Cyclopentanone (solvent): | 70.00 parts by mass |

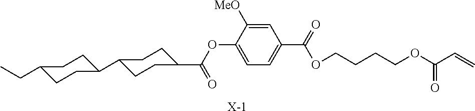 [SMILES: C=CC(=O)OCCCCOC(=O)c1ccc(OC(=O)C2CCC(C3CCC(CC)CC3)CC2)c(OC)c1 ; "X-1"]

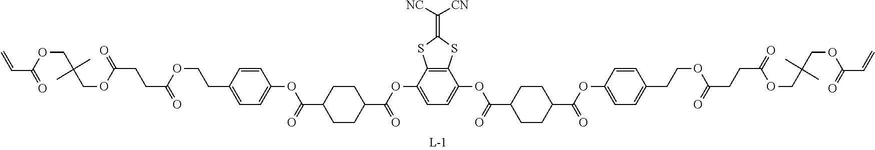 [SMILES: C=CC(=O)OCC(C)(C)COC(=O)CCC(=O)OCCc1ccc(OC(=O)C2CCC(C(=O)Oc3ccc(OC(=O)C4CCC(C(=O)Oc5ccc(CCOC(=O)CCC(=O)OCC(C)(C)COC(=O)C=C)cc5)CC4)c4c3SC(=C(C#N)C#N)S4)CC2)cc1]

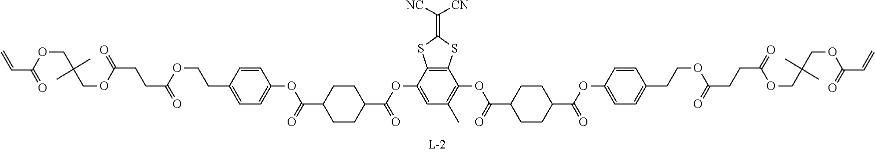 [SMILES: C=CC(=O)OCC(C)(C)COC(=O)CCC(=O)OCCc1ccc(OC(=O)C2CCC(C(=O)Oc3cc(C)c(OC(=O)C4CCC(C(=O)Oc5ccc(CCOC(=O)CCC(=O)OCC(C)(C)COC(=O)C=C)cc5)CC4)c4c3SC(=C(C#N)C#N)S4)CC2)cc1]

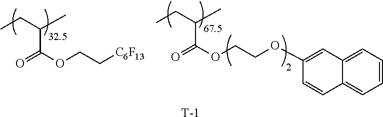

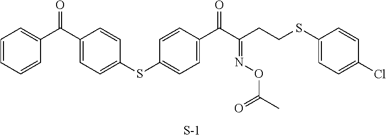

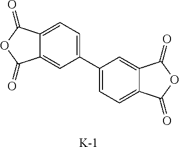

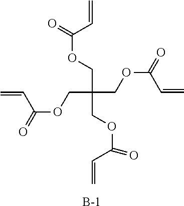

[Preparation of retardation layer 11]

A PET film (manufactured by TOYOBO Co., Ltd., A4265) having a thickness of 100 μm was prepared as a temporary support, and a PET surface on a side where an easy adhesive layer was not formed subjected to the rubbing treatment. The PET surface subjected to the rubbing treatment was coated with the coating liquid A-1 for a retardation layer prepared above using a wire bar coater, and dried at 110° C. for 72 seconds. Thereafter, the coating was irradiated with light using a metal halide lamp at 100° C., an illuminance of 80 mW/cm², and an irradiation amount of 500 mJ/cm² in a low oxygen atmosphere (100 ppm or less) to be cured, thereby obtaining a retardation film 11 in which the retardation layer 11 was formed. In this case, a coating thickness was adjusted such that a film thickness of the cured retardation layer was 3.0 μm. A phase difference of the obtained retardation layer 11 at a wavelength of 550 nm was Re=140 nm and Rth=70 nm. For the evaluation of the phase difference, the retardation layer was transferred to glass, the PET film of the support was peeled off, and then the measurement was performed using AxoScan OPMF-1 (manufactured by Opto Science, Inc.). [Production of laminated optical film]

### [Production of Laminated Film 11]

A broadband dielectric multi-layer film (trade name: APF, manufactured by 3M) was used as a reflective type linear polarizer.

A UV adhesive (Chemi-seal U2084B (manufactured by ChemiTech Inc., refractive index n after curing n: 1.60)) was applied onto the one surface of the broadband dielectric multilayer film using a wire bar coater such that the thickness was set to 2 μm. The retardation layer 11 was bonded onto the formed adhesive layer using a laminator such that a side of the retardation layer 11 opposite to the temporary support side was in contact with the adhesive layer.

After the bonding, the inside of a purge box was purged with nitrogen until the oxygen concentration was 100 ppm or less, and then the adhesive layer was cured by irradiating the retardation layer 11 from the temporary support side with ultraviolet rays of a high-pressure mercury lamp. The illuminance was 25 mW/cm² and the irradiation amount was 1,000 mJ/cm².

After the curing, the temporary support was peeled off.

In addition, the light-absorbing anisotropic layer P1 was bonded to a surface of the broadband dielectric multi-layer film opposite to the retardation layer 11 side by the same procedure as described above. Specifically, first, a PMMA film having a film thickness of 75 μm was bonded using a laminator such that a surface of the light-absorbing anisotropic layer P1 opposite to the temporary support was in contact with the adhesive layer, and the adhesive layer was cured. Further, the temporary support of the light-absorbing anisotropic layer P1 was peeled off, and the surface of the broadband dielectric multi-layer film opposite to the retardation layer 11 side and the light-absorbing anisotropic layer P1 were bonded to each other through the adhesive layer such that the surface and the light-absorbing anisotropic layer P1 faced each other. The above-described bonding was performed such that the absorption axis of the light-absorbing anisotropic layer P1 and the reflection axis of the broadband dielectric multi-layer film were parallel to each other.

By the above-described procedure, a laminated film 11 including the retardation layer 11, the broadband dielectric multi-layer film (reflective type linear polarizer), and the light-absorbing anisotropic layer P1 (absorptive linear polarizer) in this order was obtained.

### [Formation of First Adjacent Layer 11]

A hard coat layer (first adjacent layer 11) having a refractive index of 1.52 and a film thickness of 2 μm was formed on the surface of the laminated film 11 on the retardation layer 11 side, thereby obtaining a laminated optical film 11 including the first adjacent layer. The first adjacent layer 11 was produced using the coating liquid HC-1 for a hard coat layer by the same procedure as that for the first adjacent layer 1 described above.

### [Production of Laminated Optical Films 12 to 14]

Adjacent layers 12 to 14 were formed on the surface of the laminated film 11 on the retardation layer 11 side by the following methods, thereby producing laminated optical films 12 to 14.

(Formation of First Adjacent Layer in which Refractive Index Changes in Thickness Direction)

Using the coating liquids shown in Table 7 above, the coating liquids were sequentially applied to form a first adjacent layer in which the refractive index changed in the thickness direction.

By the above-described procedure, a first adjacent layer (first adjacent layers 12 to 14) in which a refractive index n4 on the retardation layer side of the first adjacent layer and a refractive index n5 on the side of the first adjacent layer opposite to the retardation layer were different from each other and the refractive index changed in the thickness direction was formed.

The film thickness of the first adjacent layer is adjusted to 2 μm by adjusting the film thickness condition of each layer.

Laminated optical films 12 to 14 were obtained by the above-described procedure.

Table 10 shows the refractive index n4 on the retardation layer side and the refractive index n5 on the opposite side of each of the formed first adjacent layers.

TABLE 10

| Adjacent layer | n4 | n5 |
|---|---|---|
| Adjacent layer 11 | 1.52 | 1.52 |
| Adjacent layer 12 | 1.53 | 1.52 |
| Adjacent layer 13 | 1.56 | 1.52 |
| Adjacent layer 14 | 1.58 | 1.52 |

### [Production of Optical Article]

The laminated optical film 11 was formed into a curved shape in the same manner as the above-described procedure for producing an optical article, except that the above-described half mirror-attached lens 1 was used and the laminated optical film 1 was replaced with the laminated optical film 11. The first adjacent layer 11 side of the laminated optical film 11 was set to be the mold side. In addition, the laminated optical films 12 to 14 were also formed in the same manner.

### Evaluation

### [Production of Virtual Reality Display Apparatus]

A virtual reality display apparatus of Comparative Example 11 was produced in the same manner as described above, except that the laminated optical film 11 was used instead of the laminated optical film 1.

The laminated optical film 11 and the half mirror-attached lens 1 were bonded to each other using a UV adhesive (UVX6282 (refractive index at time of curing: 1.50)) manufactured by Toagosei Co., Ltd. such that the adjacent layer 11 faced the half mirror-attached lens 1. The adhesive layer formed of the above-described UV adhesive corresponds to the second adjacent layer.

In addition, the laminated optical films 12 to 14 were bonded to the half mirror-attached lens 1 and incorporated into the main body of the virtual reality display apparatus in the same manner as described above, thereby producing virtual reality display apparatuses of Comparative Example 12 and Examples 11 and 12.

The refractive index of the adhesive layer was measured by the same method as described above.

In addition, the refractive index nx1 in the slow axis direction and the refractive index ny1 in the fast axis direction of the retardation layer were acquired by peeling off the retardation layer and measured by the following method.

The refractive index nx1 in the slow axis direction and the refractive index ny1 in the fast axis direction of the retardation layer were acquired by peeling off the retardation layer adjacent to the adhesive layer and measured by the following procedure. First, the specular reflectance from the back surface was processed to be 0, and then the reflection spectrum was measured with a spectrophotometer (manufactured by JASCO Corporation, ultraviolet-visible-near infrared spectrophotometer V-750). During the measurement, linearly polarized light was incident and measured.

The incidence direction of the linearly polarized light during the measurement was set to be parallel to each of the slow axis and the fast axis, and each of the refractive index nx1 of the slow axis and the refractive index ny1 of the fast axis of the retardation layer was acquired.

### [Evaluation of Ghost]

In the produced virtual reality display apparatus, a black-and-white checkerboard pattern was displayed on the image display panel, and the visibility of the ghost was visually evaluated according to the following standard. In practice, the evaluation of A to C is preferable, and the evaluation of A or B is more preferable.
A; ghost is not visible at all.
B; ghost is slightly visible, but not noticeable.
C; weak ghost is visible.
D; slightly strong ghost is visible.
E; strong ghost is visible.

The evaluation results of the visibility of the ghost are shown in Table 11.

In Table 11, the columns of Expression (7) to Expression (10) are denoted as “A” in a case where each expression is satisfied, and are denoted as “B” in a case where each expression is not satisfied.

TABLE 11

| | | Comparative | Comparative | | |
|---|---|---|---|---|---|
| | | Example 11 | Example 12 | Example 11 | Example 12 |
| Laminated | Type | Laminated | Laminated | Laminated | Laminated |
| optical film | | optical film 11 | optical film 12 | optical film 13 | optical film 14 |
| Retardation | Type | Retardation | Retardation | Retardation | Retardation |
| layer | | layer 11 | layer 11 | layer 11 | layer 11 |
| | nx1 | 1.61 | 1.61 | 1.61 | 1.61 |
| | ny 1 | 1.55 | 1.55 | 1.55 | 1.55 |
| First adjacent | Type | Adjacent layer | Adjacent layer | Adjacent layer | Adjacent layer |
| layer | | 11 | 12 | 13 | 14 |
| | n4 | 1.52 | 1.53 | 1.56 | 1.58 |
| | n5 | 1.52 | 1.52 | 1.52 | 1.52 |
| | Expression | A | A | A | A |
| | (7) | | | | |
| | Expression | B | B | A | A |
| | (8) | | | | |
| | Expression | B | B | A | A |
| | (9) | | | | |
| Second | n6 | 1.50 | 1.50 | 1.50 | 1.50 |
| adjacent layer | Expression | A | A | A | A |
| | (10) | | | | |

| | | | | |
|---|---|---|---|---|
| Ghost visibility | E | D | C | B |

From the results shown in Table 11, in the virtual reality display apparatuses of Examples 11 and 12, the ghost was at a level that was not noticeable or the ghost was weak, and the occurrence of the ghost was suppressed over the entire region of the lens. On the other hand, in the virtual reality display apparatuses of Comparative Examples 11 and 12, a part of the light in the white display region was visible as a slightly strong ghost in the black display region of the checkerboard pattern, and the occurrence of the ghost could not be suppressed.

That is, it was confirmed that, in a case where the optical laminate satisfying the requirements of Expressions (7) to (9) was applied to the virtual reality display apparatus (head-mounted display), the occurrence of the ghost was suppressed.

### EXPLANATION OF REFERENCES

10, 30: optical laminate
12, 32: first adjacent layer
20: selective reflection layer
22: first cholesteric liquid crystal layer
24: second cholesteric liquid crystal layer
26: third cholesteric liquid crystal layer
42: retardation layer
44: reflective type linear polarizer
100: laminated optical film
300: half mirror
400: circular polarization plate
500: image display panel
1000: ray

What is claimed is:

1. An optical laminate comprising: a selective reflection layer including at least one cholesteric liquid crystal layer; and
a first adjacent layer that is disposed adjacent to an outermost cholesteric liquid crystal layer disposed on an outermost side of the selective reflection layer and that is selected from the group consisting of an optically isotropic layer and a C-plate,
wherein, in a case where a half-value wavelength on a long wavelength side of a reflection spectrum of the outermost cholesteric liquid crystal layer is denoted by λmax, a half-value wavelength on a short wavelength side of the reflection spectrum of the outermost cholesteric liquid crystal layer is denoted by λmin, and the number of helical pitches of the outermost cholesteric liquid crystal layer is denoted by P, relationships of Expression (3) to Expression (5) are satisfied between nmax and nmin calculated by Expression (1) and Expression (2) and a refractive index n1 of the first adjacent layer on an outermost cholesteric liquid crystal layer side,
$$n max = λ max / P , \qquad Expression ( 1 )$$
$$n min = λ min / P , \qquad Expression ( 2 )$$
$$n max > n 1 , \qquad Expression ( 3 )$$
$$n min < n 1 , \qquad Expression ( 4 )$$
$$\vert {( n max \cdot n min )}^{1 / 2} - n 1 \vert \leq 0.03 . \qquad Expression ( 5 )$$

2. The optical laminate according to claim 1,
wherein the selective reflection layer includes a cholesteric liquid crystal layer R formed of a rod-like liquid crystal compound and a cholesteric liquid crystal layer D formed of a disk-like liquid crystal compound.

3. The optical laminate according to claim 1,
wherein a reflectance of light having a wavelength of 450 to 650 nm is 40% or more and less than 50%.

4. The optical laminate according to claim 1,
wherein the first adjacent layer has a liquid crystal alignment capability.

5. The optical laminate according to claim 1,
wherein a refractive index of the first adjacent layer changes from a surface on the outermost cholesteric liquid crystal layer side toward a surface on a side opposite to the outermost cholesteric liquid crystal layer side.

6. The optical laminate according to claim 1, further comprising:
a second adjacent layer that is disposed adjacent to a side of the first adjacent layer opposite to a selective reflection layer side,
wherein a refractive index n2 of the first adjacent layer on a second adjacent layer side and a refractive index n3 of the second adjacent layer on a first adjacent layer side satisfy a relationship of Expression (6),
$$\vert n 3 - n 2 \vert \leq 0.03 . \qquad Expression ( 6 )$$

7. A laminated optical film comprising, in the following order:
the optical laminate according to claim 1;
a retardation layer; and
a polarizer,
wherein the retardation layer is disposed on a side of the selective reflection layer of the optical laminate opposite to the first adjacent layer side.

8. An optical article comprising:
the laminated optical film according to claim 7; and
a lens disposed on a side of the first adjacent layer of the laminated optical film opposite to a selective reflection layer side.

9. An optical laminate comprising:
a reflective type linear polarizer;
a retardation layer; and
a first adjacent layer selected from the group consisting of an optically isotropic layer and a C-plate, the first adjacent layer being disposed adjacent to the retardation layer on a side of the retardation layer opposite to a reflective type linear polarizer side,
wherein in a case where a refractive index of the retardation layer in an in-plane slow axis direction is denoted by nx1, a refractive index of the retardation layer in an in-plane fast axis direction is denoted by ny1, and a refractive index of the first adjacent layer on the retardation layer side is denoted by n4, relationships of Expression (7) to Expression (9) are satisfied,
$$nx 1 > n 4 , \qquad Expression ( 7 )$$
$$ny 1 < n 4 , \qquad Expression ( 8 )$$
$$\vert {( nx 1 \cdot ny 1 )}^{1 / 2} - n 4 \vert \leq 0.03 . \qquad Expression ( 9 )$$

10. The optical laminate according to claim 9,
wherein the retardation layer contains a liquid crystal compound.

11. The optical laminate according to claim 9,
wherein a reflectance of light having a wavelength of 450 to 650 nm is 40% or more and less than 50%.

12. The optical laminate according to claim 9,
wherein the first adjacent layer has a liquid crystal alignment capability.

13. The optical laminate according to claim 9,
wherein a refractive index of the first adjacent layer changes from a surface on the reflective type linear polarizer side toward a surface on a side opposite to the reflective type linear polarizer side.

14. The optical laminate according to claim 9, further comprising:
a second adjacent layer that is disposed adjacent to a side of the first adjacent layer opposite to the reflective type linear polarizer side,
wherein a refractive index n5 of the first adjacent layer on a second adjacent layer side and a refractive index n6 of the second adjacent layer on a first adjacent layer side satisfy a relationship of Expression (10),
$$\vert n 6 - n 5 \vert \leq 0.03 . \qquad Expression ( 10 )$$

15. A laminated optical film comprising:
the optical laminate according to claim 9; and
a polarizer disposed on the reflective type linear polarizer side of the optical laminate.

16. An optical article comprising:
the laminated optical film according to claim 15; and
a lens disposed on a side of the first adjacent layer of the laminated optical film opposite to a reflective type linear polarizer side.

17. The optical laminate according to claim 2,
wherein a reflectance of light having a wavelength of 450 to 650 nm is 40% or more and less than 50%.

18. The optical laminate according to claim 2,
wherein the first adjacent layer has a liquid crystal alignment capability.

19. The optical laminate according to claim 2,
wherein a refractive index of the first adjacent layer changes from a surface on the outermost cholesteric liquid crystal layer side toward a surface on a side opposite to the outermost cholesteric liquid crystal layer side.

20. The optical laminate according to claim 2, further comprising:
a second adjacent layer that is disposed adjacent to a side of the first adjacent layer opposite to a selective reflection layer side,
wherein a refractive index n2 of the first adjacent layer on a second adjacent layer side and a refractive index n3 of the second adjacent layer on a first adjacent layer side satisfy a relationship of Expression (6),
$$\vert n 3 - n 2 \vert \leq 0.03 . \qquad Expression ( 6 )$$
